(19) United States
(12) Patent Application Publication
(10) Pub. No.: US 2025/0384625 A1
(43) Pub. Date: Dec. 18, 2025

(54) LEVEL OF DETAIL LOADING STRATEGY WITH FEEDBACK FOR RENDERING LARGE THREE-DIMENSIONAL MODELS

(71) Applicant: Autodesk, Inc., San Francisco, CA (US)

(72) Inventors: Sebastien Morel, Montreal (CA); Gerardus Silvester Slee, Toronto (CA); Ajay Vijayabalan Menon, Toronto (CA)

(21) Appl. No.: 18/915,250

(22) Filed: Oct. 14, 2024

Related U.S. Application Data
(60) Provisional application No. 63/661,454, filed on Jun. 18, 2024.
(60) Provisional application No. 63/661,471, filed on Jun. 18, 2024.

(51) Int. Cl. G06T 17/00

(52) U.S. Cl. CPC G06T 17/00

(57) ABSTRACT

Methods, systems, and apparatus, including medium-encoded computer program products, for 3D model rendering, include: obtaining, by a computer having a display device and local memory, three-dimensional scene description data structure encoding location information in a three-dimensional model of an environment, wherein the three-dimensional model is stored on a remote computer system, and the location information comprises bounding volumes for objects in the three-dimensional model; downloading, by the computer and from the remote computer system, a portion of the objects to the local memory; and rendering, by the computer, the portion of the objects along with one or more visual indicators representing a portion of the three-dimensional model that is still to be downloaded, wherein the one or more visual indicators are placed in three-dimensional space in accordance with the bounding volumes in the three-dimensional scene description data structure to provide feedback to a user regarding a status of object downloading.

### CROSS-REFERENCE TO RELATED APPLICATIONS

This application claims priority to U.S. Provisional Application No. 63/661,471, filed on Jun. 18, 2024, and U.S. Provisional Application No. 63/661,454 filed on Jun. 18, 2024. The disclosures of the prior applications are considered part of and is incorporated by reference in the disclosure of this application.

### BACKGROUND

This specification relates to visualization of three-dimensional (3D) models on client devices. Further, this specification relates to model data used in computer graphics applications, such as computer-generated animation and/or computer visualization systems and techniques.

### SUMMARY DESCRIPTION

This specification relates to level of detail loading strategy and feedback techniques for use during loading and rendering of objects from 3D models.

In general, one or more aspects of the subject matter described in this specification can be embodied in one or more methods (and also one or more non-transitory computer-readable mediums tangibly encoding a computer program operable to cause data processing apparatus to perform operations), including: obtaining, by a computer having a display device and local memory, three-dimensional scene description data structure encoding location information in a three-dimensional model of an environment, wherein the three-dimensional model is stored on a remote computer system, and the location information comprises bounding volumes for objects in the three-dimensional model; downloading, by the computer and from the remote computer system, a portion of the objects to the local memory; and rendering, by the computer, the portion of the objects along with one or more visual indicators representing a portion of the three-dimensional model that is still to be downloaded, wherein the one or more visual indicators are placed in three-dimensional space in accordance with the bounding volumes in the three-dimensional scene description data structure to provide feedback to a user regarding a status of object downloading.

Other embodiments of these aspects include corresponding computer systems, apparatus, and computer programs recorded on one or more computer storage devices, each configured to perform the actions of the methods.

The subject matter described in this specification can be implemented in particular embodiments so as to realize one or more of the following advantages. The techniques of the present disclosure support improved functioning of the computer when rendering 3D scenes based on large 3D models. By using a tile loading strategy and tile level of detail assignment to tiles (when rendering 3D models) that are tailored to the rendering limitations of a device, the performance of a client application used for the rendering, as well as the rendering device, in general can be improved. The resources of the computer can be efficiently utilized to render model geometry tailored to the rendering limitations of the device to keep the performance stable, while placeholder geometry can be render for objects and tiles that are beyond the rendering capacity of the device. The placeholder geometry can be rendered with feedback indications to provide a visual indication for the status of downloading and/or rendering of 3D model geometry of the 3D model corresponding to the placeholder geometry. The rendering of placeholder geometry along with visual indicators can be performed at low rendering cost based on scene description data that can be accessed at the beginning of processing a 3D model, once the client application has started.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to support visualization of large models in accordance with the implementations of the present disclosure.

FIG. 2 shows an example of a process to render a large 3D model of an environment according to a tile loading strategy and a tile level of detail dynamic solution that efficiently utilizes resources at a client device to support rendering of at least a portion of the 3D model in accordance with implementations of the present disclosure.

FIG. 3 shows examples of different visual representations of a tile when assigned with different categories defining priorities for downloading and rendering of object geometry within the tiles during user interaction with the 3D model.

FIG. 4A shows an example of a side-view representation of a portion of a 3D model including tiles that are assigned to a tile level of detail category for downloading and rendering in accordance with implementations of the present disclosure.

FIG. 4B shows an example of a process for categorizing tiles defined for a 3D model based on computational rendering requirements of a display device used for rendering the 3D model during user interaction with the 3D model.

FIG. 4C shows an example of a process for dynamic rendering of portions of a 3D model including object geometries and placeholder geometries that are dynamically determined based on a rendering budget of a display device used for rendering the 3D model.

FIG. 5 shows an example of a 3D model rendered by a client application on the user device where 3D model is downloaded and rendered according to implemented tile loading technique(s) in accordance with implementations of the present disclosure.

FIG. 6 shows an example of a visual representation of a portion of a 3D model downloaded and rendered according to tile level of detail loading techniques in accordance with implementations of the present disclosure.

FIG. 7 shows an example of a process to render a portion of a 3D model that is downloaded along with visual indicators representing a portion of the 3D model that is still not downloaded.

FIG. 8 shows an example of a virtual user interface rendering a VR environment including a 3D model that is rendered with visual indicators indicative of a first portion of the 3D model that is currently downloaded and a second portion of the 3D model that is downloaded and not yet rendered.

FIG. 9 shows an example of a second view of the 3D model of FIG. 8 that includes pulsating indicators for the first portion of the 3D model that is currently downloaded.

FIG. 10 is a schematic diagram of a data processing system including a data processing apparatus, which can be programmed as a client or as a server.

### DETAILED DESCRIPTION

The present disclosure describes various tools and techniques for tile loading and rendering based on a tile loading strategy and a level of detail assigned to the tiles for rendering the model geometry objects with placeholder geometry for tiles that have not been downloaded. The described techniques support stable performance for the rendering of large 3D models. For example, the described techniques support rendering of complex dense models without crashing of an application used for interacting and rendering the models. In some instances, applications can crash due to overloading from processing large data portions. Further, the describes techniques support rendering of a model that even when loaded into a local storage of a device may not be able to be displayed due to display rendering restrictions of the device defined by an available rendering budget. As such, the described techniques efficiently utilize the computational resources of a device to initiate rendering of objects' geometry according to a tile loading strategy and dynamically assigned level of detail to each tile of the 3D model. The tiles that can be rendered can be determined based on the rendering budget of the rendering device and the density of the 3D model.

In accordance with the implementations of the present disclosure, objects can be rendered progressively while a user navigates within a 3D model of an environment and changes position inside or outside of the 3D model in a user interface provided by a display device. In some implementations, the rendering can be performed in a virtual reality (VR) environment, an augmented reality (AR) environment, and/or a mixed reality (XR) environment providing a combination of VR and AR environments (referred to generally as simply “VR”). Different users can view and collaboratively interact with the same 3D model, e.g., obtained from the same remote storage, where each user can view and interact with the rendered content through same or different types of devices providing a respective user interface environment, e.g., graphical user interface, VR environment, etc. Each device can use the same encoded location information as provided by the 3D scene description data structure to render geometry, i.e., model geometry or placeholder geometry.

In some implementations, 3D models can be rendered from different devices or platforms, including desktop devices, tablets, VR devices, among other examples. Computer graphics applications include different software products and/or services that support generation of representations of 3D models for animation and video rendering, in the context of video games, as part of design and development of construction projects, or other contexts. Computer graphics applications also include computer animation programs showing views or scenes during user reviews and navigation inside or outside of a model rendered at respective user devices.

Various types of loading strategies can be used with the presently disclosed subject matter, including adaptive dynamic loading strategies for rendering 3D models, such as described in U.S. application Ser. No. 18/506,971, filed on Nov. 10, 2023, and titled, “ADAPTIVE DYNAMIC LOADING STRATEGY FOR RENDERING LARGE THREE-DIMENSIONAL MODELS”, which application is hereby incorporated by reference in its entirety. Further, the presently disclosed subject matter can be implemented in combination with the subject matter disclosure in U.S. Application No. 63/661,471, filed on Jun. 18, 2024 under Attorney Docket No. 15786-0396P01, and titled, “TILE LOADING STRATEGY FOR RENDERING LARGE THREE-DIMENSIONAL MODELS”, which application is hereby incorporated by reference in its entirety.

A VR application can require loading and rendering huge 3D models, e.g., Architecture, Engineering and Construction (AEC) models, Computer Aided Engineering (CAE) models, Computer Aided Manufacturing (CAM) models, Computer Aided Design (CAD) models) from a remote environment, such as a cloud environment (e.g., a cloud platform, cloud service or storage, other), onto a VR platform, in real-time, for conducting an immersive and collaborative design review experience in VR. Such huge 3D models can include more than three million objects or 200 million polygons within their polygon mesh. The 3D models can include several millions of geometrical objects and hundreds of millions of polygons (i.e., geometry components of the 3D models), which can make them exceptionally complex and heavy to load and render on a device running a visualization application, e.g., a VR application running on a standalone VR headset platform.

In some instances, devices used for loading and rendering a portion of a 3D model can be portable or other devices that may have very limited processing power and rendering capability. In some instances, devices can have limited rendering capabilities such as a maximum number of draw-calls as commands that can be sent from the Central Processing Unit (CPU) of the device to the graphics processing unit (GPU) to draw the model object geometry. For example, a headset device can be limited to draw-calls within the range of 1000-1500 to be used to render geometry at any given point in time through a client application. Depending on the complexity and/or density of the 3D models, and a workflow of interacting with the model by the user, e.g., by a single user or by multiple users in a collaborative session, such resource constraints for the rendering can lead to unacceptable user experiences due to poor performance of the application. Thus, the resource constraints to render a limited portion of the geometry of the model can impose limitations for the application to support the execution of a successful design review using the application.

In some instances, an application (e.g., a VR application or a user interface application for rendering 3D model in an interactive environment, among other examples) can run on a device and be used to load and render a 3D model based on loaded geometry (at least partially) from a remote storage such as a cloud storage. The application can be provided with different versions that are compatible with different devices and their hardware and software requirements, e.g., firmware, operating system, etc. In some instances, the cloud storage can be instantiated as a storage service of a cloud platform that provides resources to end users to generate, maintain, and expose 3D content, e.g., 3D models including 3D and/or two-dimensional (2D) data, for rendering. For example, 3D content can be rendered in the context of different graphical design tasks such as design review, model modification, etc.

In some instances, a remote storage can be used to managing 3D content as part of construction and/or design projects. A user interface application can receive user interactions including requests for real-time interaction with 3D content loaded from the remote storage. Based on a received interaction, a portion of the 3D content can be rendered at the device where the application is running or at a connected display device. For example, the application can be used to conduct an immersive and collaborative design review of a 3D model rendered in a VR environment, where the model is accessible at the remote storage by multiple users that render the model on their remote devices in a respective user interface provided in their respective instance of an application.

In some cases, different technical problems can occur when rendering 3D models on devices with limited loading capabilities. For example, when a complex and dense 3D model is about to be rendered, for example, as part of a VR walkthrough of the 3D model in VR by a user, due to downloading and/or rendering restrictions of the rendering device and/or the connection with the remote storage, one may not be able to be provided with enough model geometry to conduct a complete review of the 3D model. In some cases, the downloading and/or rendering of model geometry may be delayed due to the size and complexity of the 3D model and/or connectivity constraints. In those cases, not enough model geometry can be provided within a period of time from requesting to display a portion of the 3D model by a user interacting with the application. Such time delay for the rendering can be associated with poor user experience as well as confusion for the user about the status of the rendering, which can lead to triggering subsequent requests for loading the same 3D model. As such, the poor user experience and understanding of the status of loading and/or rendering, can lead to generation of subsequent requests for the same 3D content rendering, which can cause additional overloading of the application that can cause service downtime.

In some cases, if only a limited amount of geometry around the position of the user within the environment (e.g., VR environment) can be rendered, the user may not be provided with a complete picture of the model while moving within the environment (e.g., during a VR walkthrough) and can miss context as to what is being reviewed in the environment. Since the application can provide a multi-user collaborative experience but the model geometry is rendered locally on a device hardware, users may experience different model geometries rendered within the same review session, depending on where they were virtually located inside their models when doing a virtual walkthrough within the environment. This can create problems and confusion for users of the application, such as within a collaborative session, since different users may be provided with very different views of the 3D model even if the users are assigned with positions that are in close proximity to one another within the VR environment.

In accordance with implementations of the present disclosure, a tile loading strategy can be provided for a 3D model (e.g., that can be viewed by one or multiple users in a collaborative review process) to address the above-mentioned technical problems within the application, at least partially. By applying a tile loading strategy for a 3D model to generate a 3D scene description data structure that encodes location information for the 3D model and distributing the 3D scene description data structure to provide the same encoded location information to all user devices of users who are part of a collaborative VR review session, a greater amount of geometry can be rendered at the respective device while the usage of the limited number of draw-calls available on the user devices can be maintained. The 3D scene description data structure can be defined to identify multiple tiles defined for the 3D model that include a large number of objects, e.g., 500 or more objects per tile. The defined tiles include distinct sets of objects without overlap. The 3D scene description data structure can have different format including a linked list, array, queue, stack, etc. The encoded location information can include location information for the multiple tiles as well as for the multiple objects within each of the tiles. The location information comprises bounding volumes for the objects of the model, and also can include bounding volumes for the multiple tiles. By applying the tile loading strategy as well as assigning level of detail categories, the rendered geometry includes model geometry for a portion of the objects of the 3D model as well as placeholder geometry that provides general context information about the presence of 3D geometry that is not yet downloaded and/or rendered. The geometry can be selectively rendered at the different devices as part of the collaborative VR review session to provide relevant context for each user in the VR environment from the respective viewpoint of the user. The relevant context provided to each user of at each of the devices includes respective placeholder geometry generated based on the same screen description data.

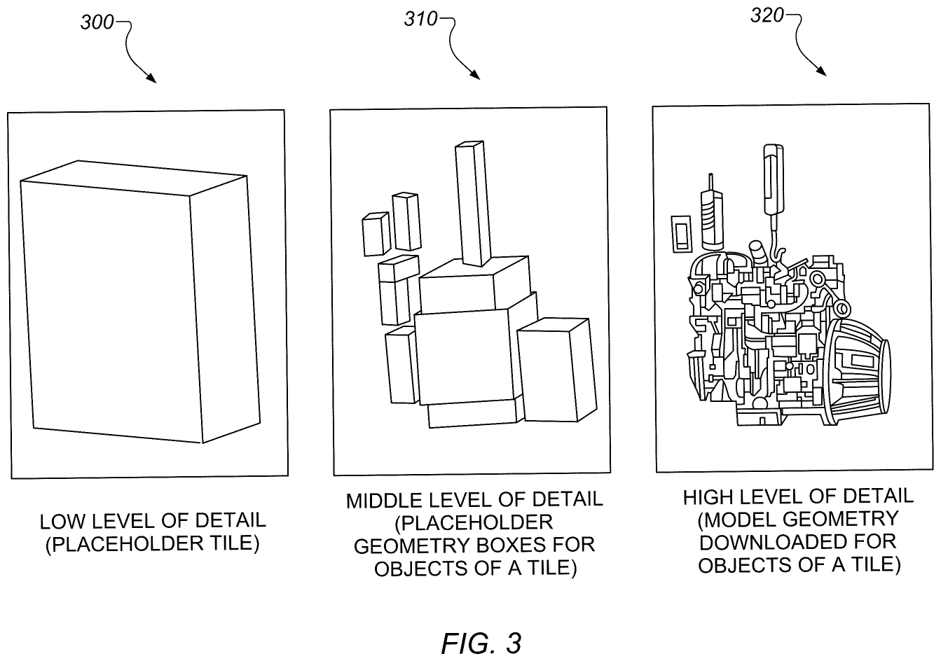

In some instances, when a portion of a 3D model is loaded and rendered on a user device to a user, another portion of the 3D model may be in progress of downloading and/or rendering. A level of detail loading strategy can be applied to the 3D model to render a downloaded portion of the 3D model including downloaded model geometry along with tiles representing a portion of the 3D model that has not yet been downloaded. In some instances, the downloaded portion of objects can be rendered with the visible model object geometry from a user's position in the environment and the tiles can be represented as placeholders (i.e., placeholder geometries) in the form of bounding boxes. A placeholder can be defined as a bounding box for a tile of objects, e.g., as shown at the low level of detail placeholder tiles 300 of FIG. 3, or as a bounding box for an object within a tile, e.g., as shown at the middle level of detail placeholder tiles 310 of FIG. 3. The bounding box that represents the placeholder can be determined based on the obtained 3D scene description data structure and does not require to download 3D geometry for objects of the model. When the level of detail loading strategy is applied, feedback techniques can be used during the rendering to provide an indication of the status of the loading or rendering of a respective tile as a placeholder for a tile or an object through visual feedback. For example, such indication can be a visual indicator, for example, that can be a particular color associated with the status of downloading, or can include a visual change, e.g., color change going through two or more colors or color shades, pulsation, etc.

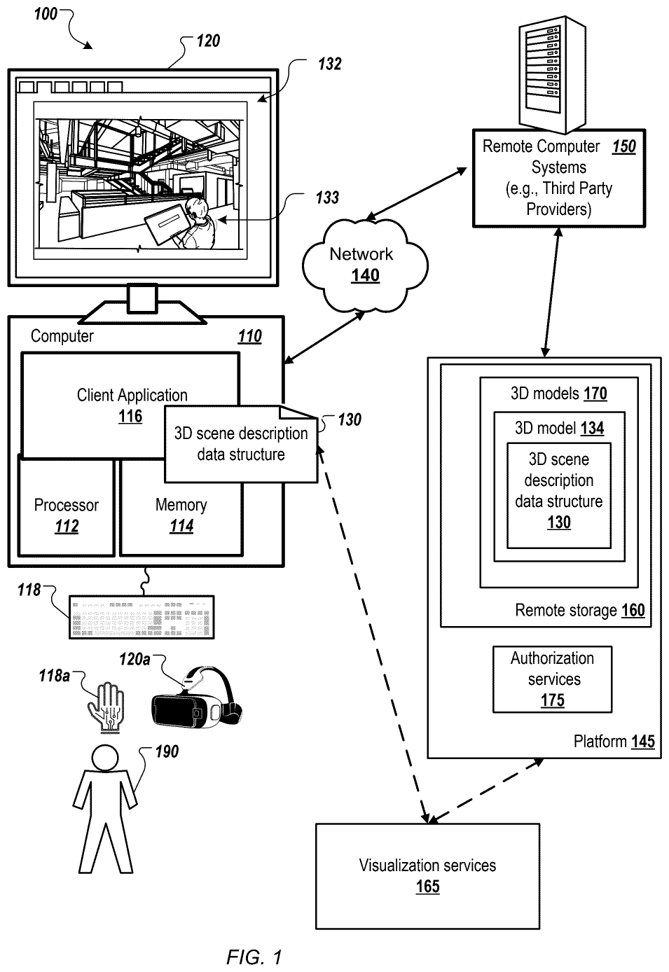

FIG. 1 shows an example of a system 100 usable to support visualization of large models in accordance with the implementations of the present disclosure. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including VR programs, AR programs, video games, or design interaction applications which support view exploration and collaboration, among other examples.

The computer 110 includes a client application 116 that includes implemented logic that supports rendering and navigating within a 3D model of an environment rendered at a display device. For example, the client application 116 can be groupware designed to support the user 190 in a collaboration process with another user (or multiple users) that uses another client application (e.g., a different version of the client application 116 that is compatible with another type of a device or operating system, or another instance of the same client application run on another device or processor), where the users can view the 3D model while navigating within the 3D model or outside of the model (e.g., perform a VR walkthrough).

For example, the client application 116 can be used by the user 190 to intentionally navigate into the 3D model to show various aspects of the model that can be rendered at another client application of another user (e.g., viewed from another viewpoint in the 3D model as specified for the other user) for the same 3D model. In some instances, the client application 116 can provide software functionality to facilitate collaborative processes between connected devices for a shared view of the 3D model of the environment. In some instances, the 3D model can be viewed from different devices while loaded and rendered data to the users at the different devices can be obtained from a single storage space, e.g., a remote storage such as a cloud storage. For example, the viewing from different devices can be part of a collaborative design process between a design user using the client application 116 to navigate within a construction project and a stakeholder of the construction project that is presented with a view (e.g., another view or a similar view) of the model. The view of the model can be provided from outside and/or inside of the 3D model. When the model is loaded and rendered at respective devices, the tile loading strategy defined for the 3D model can be applied universality to both devices, while different or similar level of detail can be determined when portions of the model are rendered. The level of detail can be dynamically determined, after the VR application has been started. On each device, each tile of the 3D model can be categorized into a respective level of detail based on the respective location of the user in the environment (e.g., visually presented in the environment with their respective avatars) and the rendering budget that is available at the respective device.

The client application 116 can run locally on the computer 110, remotely on a computer of one or more remote computer systems 150 (e.g., one or more third party providers' one or more server systems accessible by the computer 110 via the network 140) or both locally and remotely. In some implementations, the client application 116 can be an access point for accessing services provisioned on a platform 145 (e.g., a cloud platform) that provides resources for rendering of object model data stored at a remote storage 160 on the platform 145 (e.g., a cloud storage service).

In some implementations, the computer 110 can impose display rendering restrictions on the amount of data that can be processed, downloaded, and rendered at a display device. For example, a 3D model can be a large, complex, and dense model that can take a long period of time (e.g., a minute or two) to load in full. In some cases, the rendering of large volumes of data can be delayed or even the memory of the computer 110 can crash if the loading operations overwhelm the capacities of the computer to process and render all objects part of the 3D model. Such problem can be avoided by implementing tile loading strategy techniques and a tile level of detail solution to adjust how and when to render loaded geometry within an application in accordance with implementations of the present disclosure. By using such techniques, model objects from a particular scene, which is within a field of view of a user, can be prioritized to be downloaded and/or rendered first. For example, a portion of the model that is not yet downloaded can be rendered as tiles in the form of placeholder geometry bounding boxes. Such rendering as placeholder geometry bounding boxes can be performed based on categorizing the tiles to a low level of detail tiles. For example, a portion of the model could have been already downloaded but could be associated with tiles that are categorized into a middle level of detail category. In such case, rendering the model geometry for such a portion of the can exceed the rendering limit for the device at the moment. Thus, objects from middle level of detail tiles can be rendered as placeholder bounding boxes per object. The placeholder geometry can be rendered for tiles that are determined with low level of detail or with middle level of detail due to computational resource restrictions (e.g., restriction on the number of draw-calls to render more objects) at the time of the evaluation of the tiles and assigning the respective level of detail category to each tile. Also, such techniques can support stable rendering performance at the user device that improves the user experience and is considerate of the memory capacity of the device. The determination of the level of detail for each tile of a 3D model can be dynamically determined while the user is changing their position in the VR environment. As such, when the user is associated with a new position in the VR environment, the 3D scene description data can be used to re-evaluate the levels of detail assigned to the tiles of the 3D model to be used for determining downloading and rendering priorities for future display of portions of the 3D model to the user.

In some implementations, the client application 116 can request to render a model where the model is too large to fit in the cache of the computer 110 and/or the computer 110 cannot render objects of the model without a significant delay that can cause user confusion as to the status of the loading/rendering. By using the tile loading strategy and tile level of detail assignment to tiles (when rendering 3D models) that is tailored to the rendering limitations of a device, the performance of the client application 116 and the rendering in general can be improved. The resources of the computer 110 can be efficiently utilized so that even if no more model geometry is rendered (to keep the performance stable), placeholder geometry is render for objects in tiles that are not yet downloaded at low rendering cost based on scene description data that can be accessed at the beginning of processing a 3D model at the client application 116. As such, the device resources are utilized to initiate rendering of at least a portion of the model geometry while managing stable performance and providing an indication to the user for more geometry that is not yet loaded and rendered. The applied techniques improve the performance of the client application 116 without negatively impacting the user experience. These techniques also support dynamically determining object geometry to be rendered that would not cause downtime for the client application and/or the computer, which improves the functioning of the computer 110 and thus support an interaction of the user with the VR interface where geometry (e.g., model geometry or placeholder geometry) is rendered. The determination of the level of detail for rendering portions of the 3D model is performed dynamically while the user is navigating within the 3D model. Such determination is performed after the client application has been started and based on tracking the position of the user within the VR environment, and thus, supports prompt and efficient rendering of relevant geometry that provides context for the geometry of the model that cannot be rendered due to display rendering restrictions of the device and which ultimately improves the user experience. The improvement of the user experience is supported based on the utilization of a tile loading strategy that supports the rendering of placeholder geometry for model geometry that if rendered would overload the application or computer to proceed with rendering any portion of the 3D model. The computer 110 performs the rendering based on specific instructions for the geometry to be rendered that are defined with consideration of the computational and rendering resources of the computer 110.

In some implementations, when the client application 116 is used to render objects from a model on the remote storage 160 of the platform 145, the client application 116 can obtain a 3D scene description data structure (such as the 3D scene description data structure 130) encoding location information in the 3D model that can be processed to determine a portion of the objects of the 3D model that are to be downloaded and rendered together with 3D tiles representing other portion of the 3D model that has not yet been downloaded. The downloading of a portion of the object can rely on a tile loading strategy to select which tiles including objects of the model to render when navigating a user through views and scenes of the 3D model. The tile level of detail can be assigned to the tiles to define how and when to render the model object geometry or placeholder bounding boxes (based on the obtained 3D scene description data structure rather than the geometry of the 3D model).

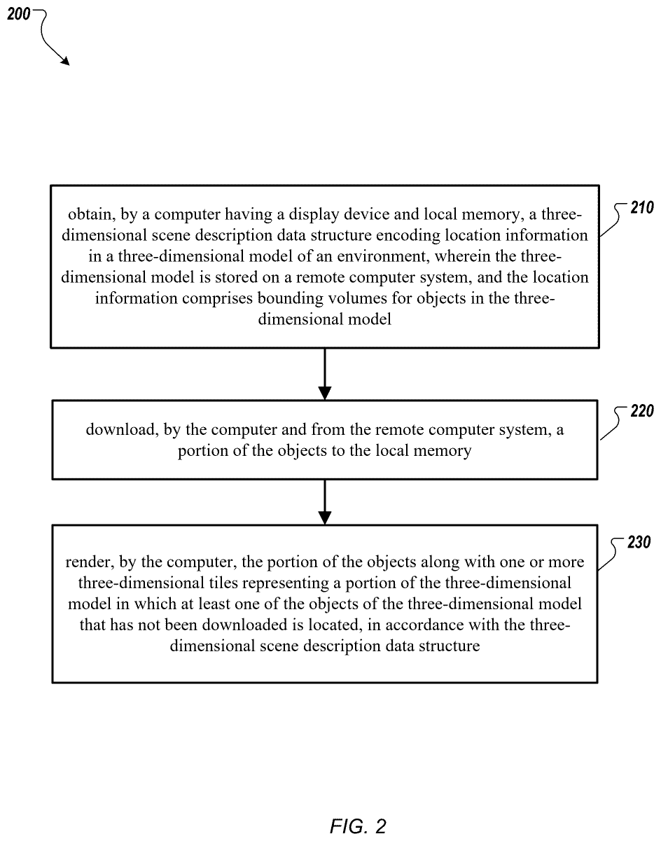

In some implementations, the client application 116 obtains the 3D scene description data structure 130 (e.g., a model description of a construction design, floor plans, etc.) associated with a 3D model of the 3D models 170 from the remote storage 160 or through a visualization service 165 that can provide data for 3D models stored at the platform 145 or at another remote service or platform. The 3D scene description data structure 130 can be provided to the client application 116 when a user, such as user 190, requests to interact with the 3D model. The 3D scene description data structure 130 can include a definition of multiple tiles defined to include distinct sets of objects of the 3D model. The definition of the tiles can be performed at the platform 145, or at the visualization service 165, for example, by applying a tile loading strategy for the 3D model in accordance with the present disclosure. In some instances, the definition of the 3D scene description data structure 130 that is to be used for loading and rendering object geometry can be done according to other techniques. The 3D scene description data structure 130 can be used to determine when and how to render geometry associated with different objects, e.g., as part of tiles defined according to an applied tile loading strategy. When geometry is rendered, e.g., at a display device such as display device 120, the geometry can represent model object geometry as part of the 3D model or can be placeholder geometry that is rendered instead of rendering model object geometry corresponding to tiles and objects included in that part of the 3D model. In some instances, the rendering of model object geometry, placeholder geometry for tiles, or placeholder geometry for objects within given tiles can be performed according to tile level of detail assignment techniques (optionally including feedback techniques) in accordance with the present implementation, for example, as described in relation to FIGS. 2, 3, 4A-C, and 7.

In some implementations, the platform 145 can be a cloud platform that can provide cloud services and resources that relate to data visualization in different display modes and can support tools and techniques to interact with the data to navigate in a display mode. In some instances, the visualization service 165 can be provisioned as a service provided by the platform 145.

In some instances, the user 190 can interact with the client application 116 to initiate or join an already initiated virtual world (a computer-generated representation of a physical world, such as an interior space of a house, a representing a collaboration space, and/or another 3D space) based on a 3D model, such as the 3D models 170 provided by the platform 145. The user 190 can navigate within the space (e.g., virtual environment) and view at least a portion of the 3D model provided by the platform 145. The downloading and rendering of portions of the 3D model to the user can be performed as described throughout the present disclosure.

In some implementations, the remote storage 160 can store multi-dimensional data including 3D models, image data, floor plans, etc. In some implementations, the platform 145 can include data for users (or accounts of users) that are associated with access rights for reading, writing, modifying, copying, or other operations to be performed when working with data on the remote storage 160. For example, the user 190 can be defined as a user associated with an account provided with access right to a 3D model 134 and to 3D scene description data structure 130 in the form of the 3D spatial data structure. The access privileged for users with accounts at the platform 145 are stored at an authorization service 175.

In some instances, the 3D scene description data structure 130 for the 3D model 134 can be generated at the visualization service 165 that has access to the 3D models 170 provided by the platform 145. The visualization service 165 can use the 3D model (such as the 3D model 134) to generate a 3D scene description data structure (such as the 3D scene description data structure 130) by applying a tile loading strategy in a substantially similar manner as the one used to generate the 3D scene description data structure 130. The 3D scene description data structure can be provided for use by the client application 116 when downloading and rendering object geometry for the 3D model at the computer 110. The rendering can be performed at the display device 120 or another rendering device connected to the computer 110.

In some cases, the visualization service 165 can obtain the 3D scene description data structure 130 as generated at the platform 145 and directly provide it to the client application for executing rendering in accordance with implementations of the present disclosure. The visualization services 165 can stream the 3D scene description data structure (or the scene description data encoding the location information) to the client application 116 (e.g., in a communications stream over the network 140) to initiate processing of the 3D scene description data structure to trigger rendering according to assigned tile level of details for the tiles defined for the 3D model as per the tile loading strategy. For example, in response to obtaining the 3D scene description structure 130 at the client application 116, and also determining a location of the user 190 in the VR environment rendered by the client application 116, a categorization of tiles defined for the 3D model can be generation to assign a respective level of detail to each tile that can be used to determine rendering priorities in accordance with implementation of the present disclosure.

In some instances, a tile loading strategy can be generated and applied for a 3D model to divide and group objects of the model into tiles. In some implementations, the tile loading strategy can be generated based on processing and loading relevant factors to determine a number of objects to be included in each tile defined for the 3D model. For example, the tile loading strategy for a 3D model can be generated in consideration of the model density and a number of objects in the 3D model, as well as in consideration of processing time (including time to process the tiles to identify tiles that include objects that are to be downloaded and rendered, as well as time to download objects of identified tiles, and also time for from rendering in view of rendering capacity limitations of a rendering device). In some instances, the considerations for processing time can be based on evaluation of past performance data related to rendering 3D models at multiple devices, e.g., of similar or different computational and rendering capabilities. In some instances, performance of client applications used to render portions of 3D models according to the present implementations can be monitored and evaluated. Past performance data can be obtained and evaluated based on defined rules or metrics that consider various factors including performance of processing a 3D scene description data structure encoding location information associated with the number of defined tiles for the respective model. In some instances, the evaluation can be based on considerations for performance to download and/or render objects on different devices. For example, different types of devices can be used to render the same 3D model, and the tile loading strategy can be defined to optimize the performance of processing, downloading, and rendering for all the devices to provide a stable performance and maintain high availability of the client application used for the rendering.

In some instances, by evaluating the performance (with regard to time, storage, computational and rendering resources) when rendering different 3D models (such as size and density of the 3D models) on different types of devices, a rule set can be generated to support a determination of a tile loading strategy for a given 3D model based on input including at least one of a number of objects in the model, size of the 3D model, density of the 3D model, type of a device, specific rendering characteristics or limitations for the rendering, other. The generated rule set can be used to generate a relevant tile loading strategy for a given 3D model that can be provided for processing at the client application 116. Tile level of detail categories can be assigned dynamically to tiles of the 3D model and a portion of the model geometry as well as placeholder geometry can be rendered by the computer 110 in accordance with implementations of the present disclosure.

In some instances, tiles defined for a 3D model can be created as a bounding volume hierarchy. The bounding volume hierarchy can be defined as a three data structure, where the higher a tile is in the structure, the bigger the objects it references in the bounding volumes in that respective tile. When tiles are processed according to their respective bounding volume hierarchy, each bounding volume hierarchy splits the processing work based on position and/or size of the objects in that tile. At runtime, when rendering of geometry of the 3D model is to be performed for a user device based on a given user position in the 3D space, the boundary volume hierarchy can be processed (e.g., traversing the three data structure) to determine one or more tiles that are within an area of interest for the user. For example, tiles that intersect or are within a volume defined within the view frustrum can be determined. When a tile that is processed is determined to have a bounding volume which when projected on a screen space is within a threshold size range to be considered as a tile that is not too small, the tile is identified for performing rendering. For example, the tile is added to a rendering queue. If the tile is determined to be below the threshold size range, the tile can be considered as small enough and traversing of other tiles that connect with that tile can be terminated. Once the hierarchical structure is traversed, the tiles that are identified for performing rendering can be sorted based on their projection screen size so that tiles that are of the largest size are first in the order (have highest priority for rendering). Since the processing is over a bounding volume hierarchy, it is understandable that tiles that are with the largest size are tiles that include bigger objects of the 3D model. The queue with the tiles in the sorted order is iteratively processed to check if each individual object within the tile would be visible in the volume or not. The determination can be performed based considering the relative positions of the objects in the tile and the user's position in the 3D space. Rendering costs for the tiles can be computed based on determining a number of draw-calls and a number of polygons that are visible for a given tile. The cost for each tile in the sorted order is evaluated to determine whether the rendering budget of the user device can handle the rendering. If the rendering budget can allow to render a tile, that tile can be added to a queue for loading with the highest resolution (i.e., a high level of detail category) and during the tile that the tile is downloaded, the tile can be represented as a tile of a low level of detail category. If the rendering budget of the device does not allow for a tile to be rendered (the tile's rendering costs do not fit into the rendering budget of the device), it can be determined whether costs associated with rendering the tile with a lower level of detail can fit into a device rendering budget for low resolution rendering (e.g., for rendering of tiles as middle level of detail tiles and/or low level of detail tiles). Such tile can be added for rendering as a low level of detail or a middle level of detail tile, where in some cases the tile's object geometry can be triggered for downloading but still that geometry would not be rendered until the tile is not reevaluated and categorized with a high level of detail category. Once the rendering budget is completely utilized, the rest of the tiles in the queue in the queue, even if within the area that is supposed to be visible for the user, would not be rendered as this will require rendering costs that can affect the performance, e.g., downtime, lower frame rate, screen freeze, etc. If it is determined that the device can handle more, more tiles will be selected for display and loading in high resolution (higher level of detail will be categorized for those tiles).

In some implementations, the client application 116 can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer (e.g., a touch screen can be an input/output device 118, 120). Moreover, the computer 110 can include or be part of a VR or AR system. For example, the input/output devices 118 and 120 can include a VR/AR input controllers, gloves, or other hand manipulating tools 118a, and/or a VR/AR headset 120a. In some implementations, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc. The VR and or AR devices, either connected to the computer 110 or being standalone devices that integrate a processor or a computer (with processor and memory) and can communicate with the platform 145 and immerse users connected through these devices into a virtual environment where 3D models of objects can be presented in a simulated real-life physical environment (or substantially similar environment) and users navigate within the environment and are presented with different visual objects.

In some implementations, the system 100 can be usable to display data from 3D documents/models that can be used to generate a virtual world presented in a corresponding interface of the client application 116 (which can be a VR environment for one or more first users, an AR environment for one or more second users, and a non-VR-or-AR environment for one or more third users) that allows users to use the data to navigate and interact with the environment to move to different positions in the space of the virtual world.

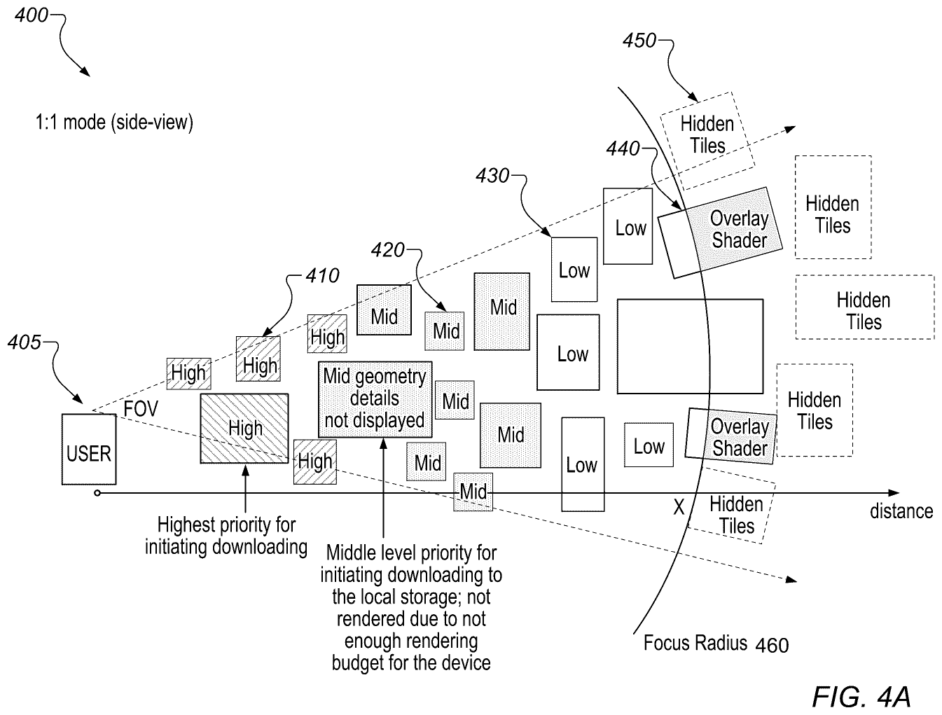

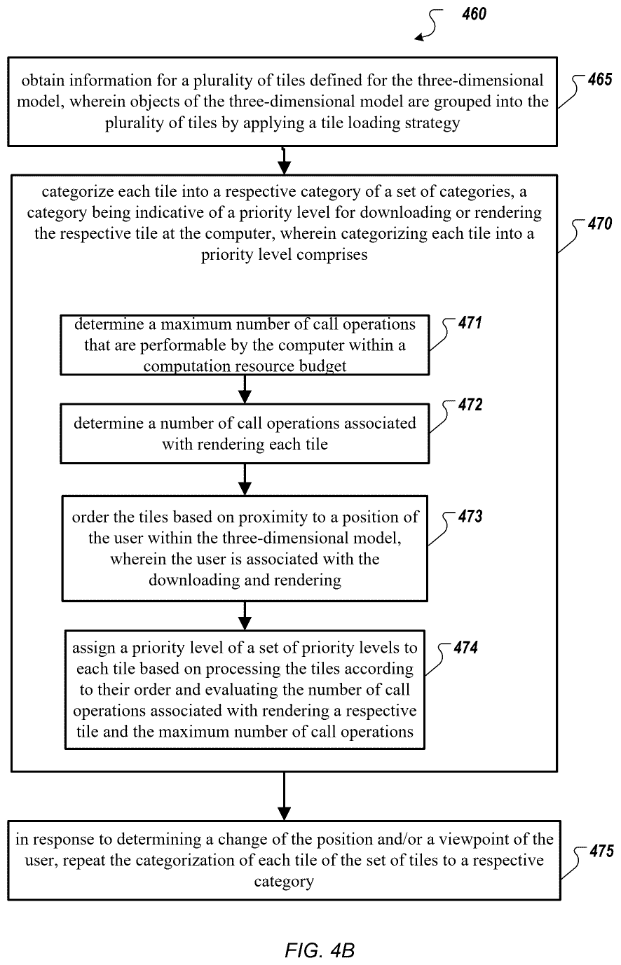

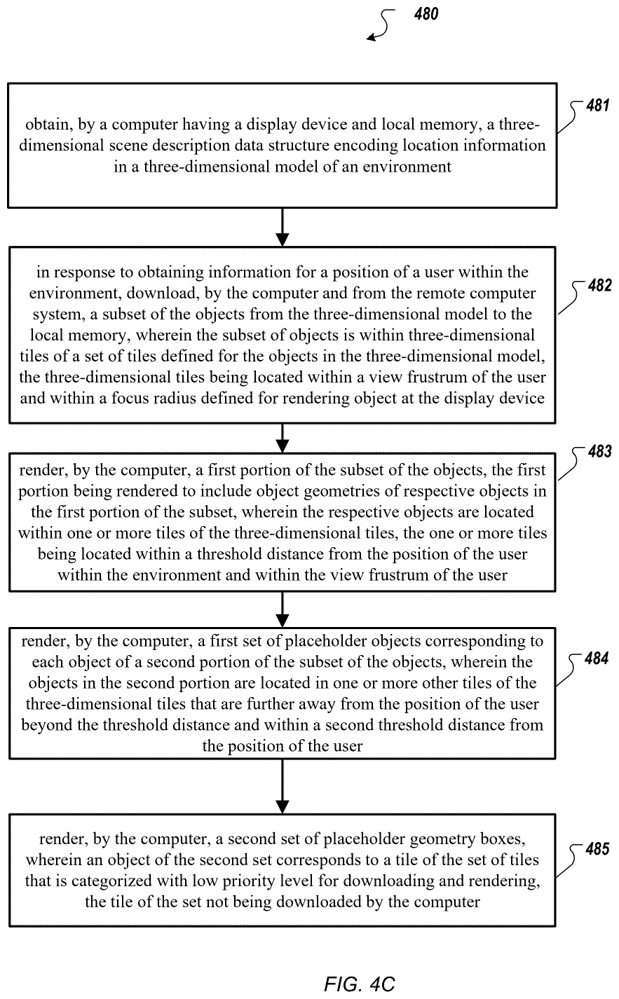

In some implementations, the user 190 can cause the computer 110 to render a view 133 of a 3D model in a user interface environment, such as the 3D model 134, that is presented on a user interface 132 of the display device 120 and visually shows how he/she (or another user) interacts with the view. The rendered view 133 of the 3D model 134 for the user (being associated with a respective avatar representing the user in the environment located at a position within the user interface environment), is generated based on processing the 3D scene description data structure 130 for the 3D model 134 in accordance with implementations of the present disclosure. The display device 120 can render a particular view of the 3D model while the user is at a particular location in relation to the model (in the example, the user is inside of the model) and the rendered view can change while the user is changing their position. In some implementations, the user 190 can be provided with the view 133 as a presentation of a view of the 3D model 134 via VR devices or other AR devices, where the user's view of the model on the user interface 132 can change while the user is navigating in and interacting with the model. For example, the view 133 can change based on a user interaction with the user interface 132 to move through positions within the model, e.g., as part of a VR walkthrough within the model. For example, the view 133 that is rendered can be rendered according to the process 200 of FIG. 2, where tiles defined for the 3D model 134 can be categorized as described in relation to FIG. 4B.

In accordance with implementations of the present disclosure, the rendering of the model 134 (i.e., at least some of the objects of the model 134) can be performed based on i) applying the tile loading strategy for defining tiles including objects of the model 134 and ii) assigning a respective level of detail to each of tiles in accordance with a viewpoint of the user (including the position and orientation of the user) within the VR environment and a rendering load limit of the computer 110 that is associated with a limited number of draw-calls for rendering at once. The systems and techniques described herein are applicable to any suitable application environment that can graphically render any portion of a virtual world, including the objects therein. Thus, in some implementations, model data from models stored at the remote storage 160 can be used for rendering objects in different modes and can be accessed from multiple types of devices, where a user can navigate within the virtual environment of the rendered model.

FIG. 2 shows an example of a process 200 to render a large 3D model of an environment according to a tile loading strategy and a tile level of detail dynamic solution that efficiently utilizes resources at a client device to support rendering of at least a portion of the 3D model in accordance with implementations of the present disclosure. In some instances, the process 200 can be executed when rendering 3D models such as the 3D models 170 of FIG. 1 and in the context of rendering through an application, such as the client application 116 running on computer 110 of FIG. 1.

At 210, a 3D scene description data structure encoding location information in a 3D model of an environment can be obtained by a computer. For example, the computer can have a display device and local memory, e.g., the computer 110 of FIG. 1. The 3D model can be stored on a remote computer system, such as a remote platform, e.g., the platform 145 of FIG. 1. The location information encoded in the 3D scene description data structure can include bounding volumes for objects in the 3D model.

In some instances, a tile loading strategy can be applied for the 3D model that helps to sort and group all the model geometry objects into multiple larger 3D Tiles. For example, if you imagine that the entire model is a huge puzzle consisting of tens of millions of tiny puzzle pieces, then the tile loading strategy helps to group multiple tiny puzzle-pieces into larger puzzle-pieces, which can be put together easily to form the whole scene.

In some instances, the 3D scene description data structure can include a definition of a plurality of 3D tiles for the 3D model that can be defined according to an applied tile loading strategy. The tile loading strategy can define how to determine a number of objects to be allocated to a tile so as to define multiple 3D tiles. The determination of how to split the objects of a 3D model into tiles can be based on i) a density of the model and ii) expected time needed to process the plurality of 3D tiles to determine objects of the 3D model to be downloaded and to render downloaded objects with regard to requests from multiple users collaboratively reviewing the 3D model from respective computers based on the 3D scene description data structure.

At 220, a portion of the objects of the 3D model can be downloaded to the local memory. In some instances, the portion of the objects that is downloaded is determined according to i) a position of a user within the environment and ii) rendering costs associated with rendering bounding volumes for objects associated with a set of tiles defined for the 3D model that is within a view frustrum of the user.

At 230, the portion of the objects can be rendered along with one or more 3D tiles representing a portion of the 3D model (another different portion) in which at least one of the objects of the 3D model that has not been downloaded is located. The rendering can be performed in accordance with the 3D scene description data structure.

In some instances, when the 3D scene description data structure is obtained for the 3D model, the downloading and the rendering can be performed based on an interaction of a user of the computer with the 3D model of the environment. The user (represented by an avatar in the environment) is associated with a location within the 3D model. The location can be within or outside of the 3D model. The downloaded portion of the objects is rendered with object geometries as downloaded from the 3D model. The downloaded portion of objects includes objects identified with high priority for downloading and rendering for the user, e.g., objects that are in close proximity with the user's location. For example, the downloaded objects can be part of tiles of the 3D model that are within a threshold distance from the user's location and within the view frustrum of the user. For example, the tiles from which objects are downloaded can be tiles that are categorized with highest priority for rendering. Such tiles can be as the tile 320 of FIG. 3, which is an example of a tile rendered with as high level of detail (and priority rendering).

In some instances, the downloaded portion is rendered along with placeholder geometry associated with one or more 3D tiles that include objects that are not yet downloaded. The rendered placeholder geometry can be for objects within a tile that can include objects that, even if downloaded, would not be within a rendering budget for rendering by the computer, e.g., based on considerations for the maximum number of draw-calls the processor of the computer can make to the GPU to render objects part of those tiles. The rendered placeholder geometry can be for tiles that are not yet downloaded.

In some instances, a 3D model can be processed according to a tile loading strategy to define tiles for the model, where in response to a request from a user with respect to rendering a view of the 3D model, a tile level of detail can be assigned to each tile to perform the downloading and rendering of model object geometry from the 3D model and/or other placeholder geometry that does not have to include loaded geometry from the 3D model. The placeholder geometry can be determined and rendered based on processing the obtained scene description data structure at a low rendering cost (comparably lower to rendering costs for the object geometry of the objects of the whole model or of the objects within the field of view of the user) to supplement the rendered view for the user. The determination of the placeholder geometry can be based on the location information about the bounding volumes as part of the 3D scene description data structure. The placeholder geometry can be considered as a replacement in the form of replacement bounding boxes for objects that are not yet loaded (e.g., due to time constraints of the download such as network bandwidth) or cannot be rendered (e.g., due to rendering limitations of the device, e.g., maximum number of draw-calls available to be executed by the computer).

In some instances, the processing of the tile loading strategy for the 3D model and the assignments of a priority level of detail for the tiles can be performed as shown and described in connection with FIG. 4A. The priority for loading and/or rendering can be assigned according to priority levels as shown and described in connection with FIG. 3.

FIG. 3 shows example of different visual representations of a tile when assigned with different categories defining priorities for downloading and rendering of object geometry within the tiles during user interaction with the 3D model.

In some instances, when a tile loading strategy is applied to a 3D model, multiple tiles are defined to include multiple objects of the 3D model. The tiles include distinct sets of objects and the number of objects within a tile can be determined based on properties of the 3D model (e.g., size and density) as well as time considerations for processing, rendering, and downloading the tiles when a model is invoked to be rendered at a user's device.

When a user requests to view a model for which multiple tiles are defined in accordance with the tile loading strategy as described in the present disclosure, a view frustrum of the user within the user interface environment can be determined, and 3D scene description data structure for the 3D model that includes information for the tiles of the 3D model can be processed based on the user's position (e.g., location and perspective) and display rendering restrictions of the rendering device. The 3D scene description data structure can be processed to determine which tiles are to be rendered with the model object geometry for the objects in the tile, or if placeholder geometry should be used to compensate for rendering limitations of the rendering device. For example, the processing of the tiles of the 3D model can be performed as described in relation to process 460 of FIG. 4B. In some instances, a tile level of detail solution can be used to assign respective level of detail categories to the tiles of the 3D model to define which geometry to display. The tile level of detail categories can be assigned to the to define how and when to render loaded geometry within an application such as the client application 116 of FIG. 1. The assignment of the levels of detail to the tiles can be performed as described in relation to FIG. 4B.

In general, the basic geometry component of a 3D model can be referred as polygons. The polygon geometry includes straight edges and vertices that form a plane called a face, which usually has a three-sided geometric shape (also called “triangular polygons”). 3D models can be rendered at user devices such as VR headsets. In some instances, a standalone VR headset can be used to render a 3D model and to provide a VR experience to the user.

An application running on a user device that is used to render a 3D geometry of a model can execute draw-calls that are commands sent to a GPU to render a specific object or element on a display screen. Each draw-call represents a set of instructions for the GPU to define how to draw a particular mesh or an image. The CPU of a device can send a request to the GPU through a graphic application programming interface (API) (e.g., OpenGL) to render an object (e.g., a VR object) on the screen. Each draw-call includes all the information the graphics API needs to draw on the screen, such as information about textures, shaders, etc.

Different user interface applications can be used to render 3D models in a 3D space and to support navigating within the 3D space in real time while the viewpoint of the user is changed as the user is navigating within the 3D space. For example, a viewpoint of the user can be initially outside of the 3D model, which can be a model of a building, where based on interaction and repositioning of a user in relation to the model within the 3D space, the user's viewpoint can be changed and the building can be viewed from the outside—from a closer distance or from far away, or from the inside. For example, the 3D model can be a model of a building and the user can be associated with a position within a particular room or floor of the building. At each change of the viewpoint of the user, different objects of the 3D model can be relevant for the rendering. In accordance with the present implementations, objects can be loaded and rendered as a user moves within the environment and the number of objects that are rendered as part of the model can be dynamically adjusted based on rendering capacity of the device, e.g., monitoring of the generated frames per second (FPS) and the memory consumption. FPS is a unit that can measure display device performance in video captures and playback and video games. FPS is used to measure frame rate—the number of images consecutively displayed each second—and is a common metric that can be used when considering video quality in video capture and playback. The metric can be considered when determining the quantity of objects for visualization, where this quantity can be autotuned iteratively while the user moves and changes their viewpoint within the model. Based on monitoring the measured frame rates and memory consumption at a rendering device, a categorization of tiles as defined by the tile loading strategy can be dynamically adjusted to scale the load on the processor to handle downloading and rendering of objects by adjusting the assignment of the priority per tile as the user moves.

In some implementations, a 3D model can be divided into tiles according to a tile loading strategy that groups objects into multiple 3D tiles. When at least a portion of the 3D model is to be downloaded and rendered through an application on a computing device, a level of detail can be assigned to each tile of the 3D model. The level of detail can define what kind of geometry has to be downloaded and rendered for each tile. In some implementations, the geometry that is to be rendered for tiles defined for the 3D model can be determined based on a category to which the tile is assigned. The category can define the level of detail of the geometry of included objects that are to be rendered. As shown on FIG. 3, tiles can be assigned with three levels of details including:
a low level of detail that is associated with rendering a placeholder tile for the tile, as shown at 300,
a middle level of detail that is associated with rendering placeholder bounding boxes for respective objects within the tile as shown at 310,
a high level of detail that is associated with rendering the model object geometry of objects within the tile as shown at 320.

One or more tiles that are determined for rendering can be rendered using a single draw-call on the processor of the computer. The number of tiles that can be rendered using a single draw-call can depend on the rendering limits of the computer that defines a maximum number of calls that can be executed at the same time by the application. In some instances, for each tile defined for the 3D model, three sets of rendering budgets can be defined that are increasingly “cheaper” (associated with fewer resources) to render. If a tile is to be rendered with all the geometry of the included objects in the tile, i.e., when a tile is associated with a high level of detail, the rendering costs of the tile would be the highest. If the tile is to be rendered with bounding boxes as placeholders for objects in the tile, i.e., when the tile is associated with the middle level of detail, the rendering costs will be lower compared to the costs associated with the high level of detail. If the tile is to be rendered with a single placeholder box for all the objects within the tile, i.e., when the tile is associated with the low level of detail, the rendering costs of the tile would be the lowest compared to costs for rendering tiles with the high and middle level of detail. As such, when a user interacts with a model, the tiles defined for the model can be sorted based on the distance to the user's position, and the tiles can be processed in such sorted order to assign them with a priority level of detail (e.g., high, middle, or low) depending on the rendering costs that can be allocated for rendering the tile in view of the rendering budget that the device is providing. The rendering budget provides a limitation for the amount of geometry that can be rendered and ultimately has an effect on the FPS rate as a measure of performance of the device.

By rendering placeholder geometry, e.g., as placeholder tiles or bounding boxes for objects for tiles assigned with a middle level of detail, the user is provided with a view that represents (in the visualized space) geometry that is not yet rendered. The rendering of such placeholders or bounding boxes is performed at a lower rendering cost compared to the rendering cost for rendering the model geometry for all the objects included in those tiles. The rendering of placeholders and bounding boxes is based on the scene description data structure that can be accessed quickly at the beginning of the process, e.g., with the obtaining of the scene data at 210 of process 200 of FIG. 2.

### Low Level of Detail Tiles (Placeholder Tiles)

The low level of detail tiles as shown at 300 of FIG. 3 are tiles which are associated with objects of the 3D model that are yet to be downloaded from a remote storage or loaded from a cache storage of the device used for the rendering. When a tile is categorized as a low level of detail tile and rendering of a portion of the model is provided to the user, the geometry that corresponds to that tile is either not yet downloaded from a platform providing the 3D model (e.g., the platform 145 of FIG. 1, or a cloud storage or service) or is not yet loaded in the tile, e.g., from a cached model file on a device storage. These tiles can be wholly represented or rendered as a single geometric “box”, i.e., a placeholder box, regardless of the number of objects grouped within them. Note however, that tile load and loading geometry are two distinct concepts. A tile load selection (i.e., determining which tiles to render by the user device to the user) is related to rendering budgets of the rendering device. As tiles are sorted by distance to the position of the user in the user interface environment, the tiles can be processed in order of proximity to the user and can be assigned a priority level for downloading and rendering them depending on whether the rendering cost of rendering them by the device with the object geometry is within the rendering budget of the device for a specific level of detail (high, medium, or low). When a tile is assigned with high level of detail priority, the real geometry associated with objects of that tile is desired to be displayed and the downloading of the geometry of the objects part of the tile is initiated so that the geometry can be rendered as soon as it is downloaded. In case that some object geometry of an object part of a tile assigned with high level of detail is not yet downloaded, the object can be represented with a placeholder bounding box that is generated based on the scene description data obtained for the 3D model. Thus, the full context of a 3D scene can be provided to the user very quickly by rendering placeholder bounding boxes for most or all of the tiles (within the user's view frustrum) as soon as the scene description data is obtained for the 3D model, and then actual geometry is rendered within the high level of detail tiles as soon as that geometry is available, thus fleshing out the 3D scene for the user as time progresses.

### Middle Level of Detail Tiles

These are tiles with geometry that is to be downloaded from a remote storage (e.g., a cloud store or loaded from a cached model file on a device storage) once the high level of detail tiles are downloaded, however, middle level of detail tiles are tiles that are not yet rendered in the highest level of details (i.e., to include rendering of the object geometry as downloaded) because of limitations associated with the rendering on the device. The limitations are imposed based on an available rendering budget that is considered as the ratio between the hardware's performance and FPS. Each object within these tiles is rendered as a geometric bounding box and the number of boxes is equal to the number of objects grouped within a tile.

In some instances, each box can be rendered as placeholder geometry at minimal rendering cost, where the box can be provided with a visual indicator to define that the geometry is downloading but not yet rendered or about the be rendered. Such visual indication can be provided through using the color of the object it represents when the geometry box is about to be drawn by performing a draw-call send to the GPU. The visual indication of a geometric box based on a color can be performed by combining different colors to be used with the defined draw-call limit without adding additional rendering tasks.

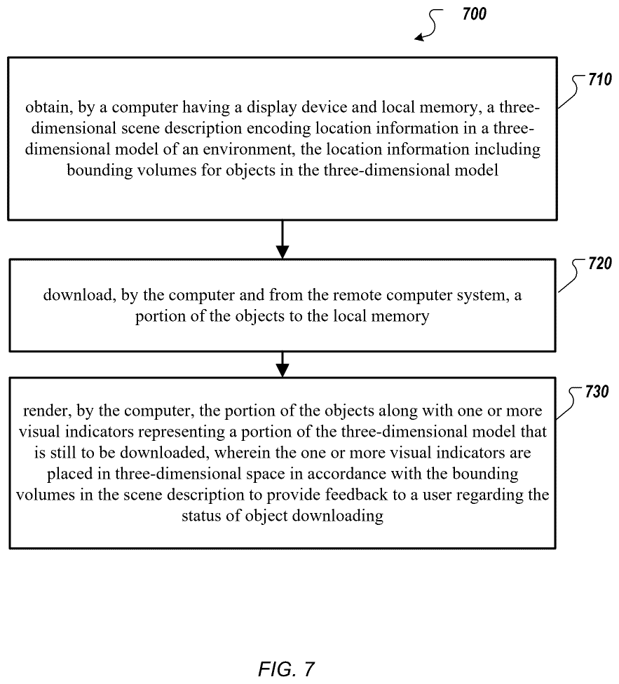

In some instances, the visual indication with which a geometric box can be rendered can also include pulsation, where the pulsation can be configured by utilizing the GPU to render many instances of an object within a single draw-call. As such, without increasing the number of draw-calls, a visual indication such as color or pulsation can be added to render geometry boxes as placeholder geometry for geometry in tiles that are categorized as middle level of detail tiles. The rendering of geometry of the 3D model with feedback indication as to the status of downloading and rendering can be performed as described in relation to FIGS. 7, 8, and 9.

Since the objects that are part of the tile are visualized as geometric boxes, the rendering costs for multiple objects are lower compared to rendering placeholder geometry for those objects that has another shape that may be closer to the shape of the object, and the geometric boxes can be readily rendered from various perspectives and locations as the user is navigating within the model. Thus, the utilization of a geometric box as a shape of the placeholder object supports reduced complexity in rendering the placeholder geometry. Thus, by rendering placeholder geometric boxes for objects that would not be able to be rendered due to rendering restrictions of the rendering device, the 3D scene can provide more context information about the existence of other 3D objects even if they are not rendered with their model geometry. The provision of such context information can be performed quickly based on using the 3D scene description data to render placeholder bounding boxes for the objects within a tile. The rendering of the actual geometry for such objects can be provided to the user as time progresses and based on re-evaluation of the level of detail for the tiles based on changes of the position of the user in the 3D environment.

### High Level of Detail Tiles

Tiles that are assigned with a high level of detail category are tiles with geometry downloaded from a remote storage (e.g., a cloud storage or loaded from a cached model file on the device storage), and fully rendered in the highest level of details to include the model geometry of the objects in the tile as defined in the 3D model. However, note that in cases where the geometry of objects from high level of detail tiles is not yet downloaded/loaded, placeholder geometry can still be displayed to show these tiles as middle level of detail tiles (or low level of detail tiles) until their geometry is fully loaded.

FIG. 4A shows an example of a side-view representation 400 of a portion of a 3D model including tiles that are assigned to a tile level of detail category for downloading and rendering in accordance with implementations of the present disclosure.

In some instances, a user 405 interact with an application, such as the client application 116 of FIG. 1 and can request access to a 3D model. Based on the request, the user can be assigned a position within an environment, e.g., VR environment, in which at least a portion of the 3D model is to be rendered for the user in accordance with techniques of the present implementation. For example, the rendering of a portion of the 3D model can be performed as described in relation to FIGS. 2, 4C, and 7.

In some instances, rendering of a view of the 3D model for a user can be performed at a user device including a display, e.g., VR headset providing a VR screen supporting user viewing and interaction. The 3D model can be stored at a remote data storage, e.g., such as a cloud storage, or from a remote storage to the user device, e.g., local storage of a server system. The 3D model can be too large to be loaded in full on the device within an initial threshold time period. To perform rendering of a view of the 3D model while maintaining stability in the device performance, a tile loading strategy can be applied to the 3D model and the tiles can be categorized into their respective level of detail, e.g., as described in relation to FIGS. 1, 2, 3, 4B, 4C, and 7. When the view of the 3D model is about to be rendered, scene description data structure generated for the 3D model can be provided to the rendering device to include a definition of tiles for the 3D model (as defined by an applied tile loading strategy). The location information encoded in the scene description data structure can be used to render the view based on a downloaded portion of objects along with placeholder bounding box geometry for tiles and/or objects that are not yet downloaded or not yet to be rendered in view of rendering limitations of the device.

The side-view representation 400 can be associated with a field of view of the user 405 and in relation to at least a portion of the objects of the 3D model. A tile loading strategy is applied to the 3D model so that the objects are divided into tiles according to considerations of model size and density, as well as expected computational resources associated with downloading and rendering a 3D model on which such a tile loading strategy is applied. As shown at the representation 400, the user 405 has a view frustrum that corresponds to the area between the dash-lined arrows that form a portion an area around the user 403 (note that only two dimensions are considered here for ease of description, but in practice, the view frustrum defines a 3D region within the 3D space in which the 3D model is located, and not simply an area). Some tiles of the model are partially overlapping with the area of the view frustrum, e.g., tile 410, while other tiles are entirely within the view frustrum, e.g., tile 420 and tile 430. There can also be tiles that are completely outside of the view frustrum (not shown). A focus radius 460 can be defined for the user based on the device capabilities for rendering. The focus radius 460 is defined as the nearest distance to the tile that cannot be rendered due to rendering budget limitations of the rendering device, which correlates with how good the performance/FPS will be for the rendering of the 3D model. The tiles that completely fall outside the focus radius 460 are hidden and not rendered. The focus radius 460 can be determined based on the rendering budget of the device as well as on the density of the 3D model. The budget for rendering provided by the device represents the maximum amount of draw-calls that the device can perform to render objects. When a tile includes multiple objects and their object geometries are to be rendered by the device, the draw-calls associated with such a tile correspond to the number of objects within the tile.

In the example representation 400, the tiles that at least partially overlap with the view frustrum of the user are categorized into one of the three level of detail tile categories as shown and described in connection with FIG. 3. When applying a level of detail categorization to each tile of a 3D model to determine what geometry is to be rendered, those tiles of the 3D model that are in the immediate vicinity of the user 405 (e.g., within a first threshold distance from the position of the user 405) and those that are within the user's view frustrum would be assigned with a high level of detail category, e.g., such as the high level of detail tile 320 of FIG. 3. The tiles that are assigned with such high level of detail category are to be downloaded and rendered as soon as they are downloaded. Tiles that are within the view frustrum but within a subsequent distance threshold range from the position of the user 405, would be assigned with the next level of detail category (or a priority level for rendering) such as the middle level of detail tile 310 of FIG. 3. Such tiles in the middle level of detail can be triggered to be downloaded but would not be rendered until the rendering limitations of the device allow recategorization of the tile and subsequent rendering.

For example, the tiles that are assigned with the high level of detail category, are those marked with a line pattern (used for all tiles assigned with a high level of detail category) and are within an area of the user's view that is in close proximity to the user 405, e.g., within the threshold distance that defines a first radius for a curve around the user 405. For example, tiles that are at a distance above the first threshold distance and below a second threshold distance, such as tile 420 (annotated with a dotted pattern that is associated with all tiles assigned with a middle level of detail category), can be assigned with a middle level of detail category and given next level of priority for rendering and rendered with a placeholder geometry box for each of the objects within a respective tile. The tiles, such as tile 430 and tile 440, which fall further away from the user's location but which are within or intersect with the user's view frustrum and the focus radius 460 (as the overlayed tile 440) can be rendered as low level of detail tiles, i.e., with a placeholder geometry box for the whole tile. The tiles that are outside of the focus radius 460, even if wholly or partially within the view frustrum, such as a tile 450, are not categorized with a level of detail category and are hidden.

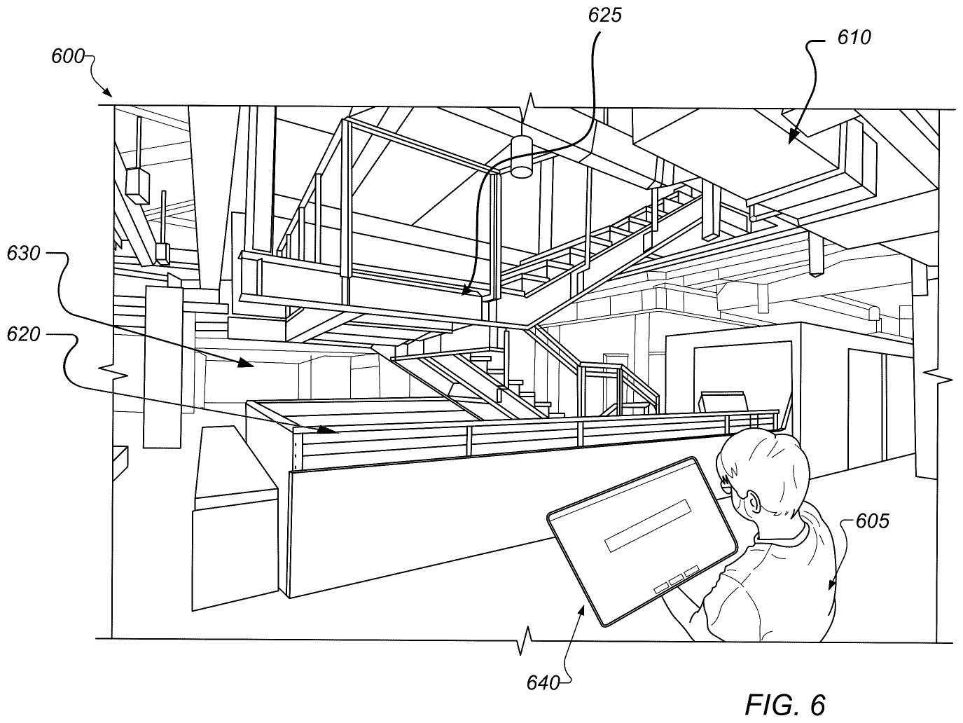

The user 405 can be provided with a real-time immersive VR experience while the user 405 moves around in the 3D model, as part of the user interaction with the rendered environment. As time progresses, the tiles of the 3D model can switch their assigned category. Based on repositioning of the user 405, tiles that were previously assigned with a low level of detail category can be assigned with a middle or high level of detail category, or vice-versa. The recategorization of tiles to a particular level of detail category can be performed in real time and depending on the current user's position and orientation within the 3D environment. Such dynamic recategorization of objects based on user's repositioning supports smooth adjustment of the rendered geometry for the user while still maintaining the context of the 3D scene by providing placeholder geometry. Based on the dynamic recategorization, objects that are within immediate vicinity of the user are to be rendered in high level of detail as soon as they are available. As such, the visual representation of a view of the 3D model for a given user can be quickly generated based on relying on the location information about the tiles that can be processed efficiently to determine the geometry that should be rendered for the 3D scene to provide context information to the user. The location information about the tiles and respective objects supports prompt generation of placeholder geometry instead of rendering complex model geometry that can cause rendering interruptions such as freezing or downtime for the rendering device due to processing and rendering overload. For example, a 3D model can be rendered according to a tile loading strategy and tile level of detail categorization to render visual representations as shown and described in connection with FIGS. 6 and 7.

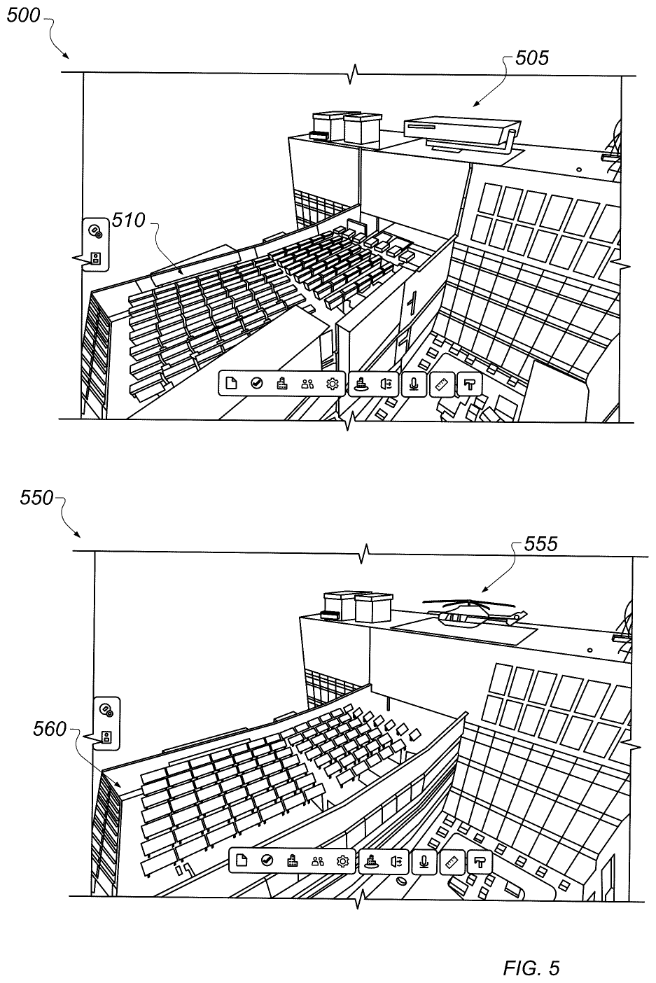

Turning to FIG. 5, FIG. 5 shown an example representation 500 of a 3D model that would be rendered if the techniques of the present application, e.g., as described in relation to FIGS. 1, 2, 3, 4A-C, are applied. The representation 500 is rendered by relying on techniques of applying a tile loading strategy and level of detail categorization of tiles (as described in the present disclosure) when rendering at least a portion of a 3D model that is in accordance with implementations of the present disclosure.

The representation 500 on FIG. 5 includes placeholder tiles that can be rendered for tiles that are categorized as low level of detail tiles or placeholder geometry boxes for objects that are part of a tile categorized as a middle level of detail tile. For example, a helicopter as shown on FIG. 5 is rendered as a placeholder tile 505, since the tile corresponding to the object “helicopter” (or objects that form the helicopter) was categorized as a low level of detail tile. Further, the solar panels on the roof of the left side of the building are rendered with placeholder geometry, for example, as the placeholder geometry box 510 for one of the tiles. For example, “solar panel” object that corresponds to the geometry box 510 was part of a tile that is categorized as a low level of detail tile, or the multiple solar panels on the roof top can form one tile that can be categorized as a middle level of detail tile so that each object of the tile that represents a solar panner can be rendered with placeholder box geometry. Other portion of the rendered view of the 3D model at 500 also includes placeholder geometry that is not geometry downloaded from the 3D model. The placeholder geometry is rendered to provide a fuller view of the 3D model while a portion of the model is not yet downloaded and/or there is no rendering budget to render more geometry of the 3D model as determined according to techniques of the present implementation.

The representation 500 of FIG. 5 includes rendering of tiles with a different level of detail, including rendering of placeholder geometry (either for tiles or for objects of a given tile) that is determined to be render dynamically once the application used for the rendering has been started. The categorization of tiles to a respective level of detail, as shown and described in connection with FIGS. 3 and 4B, can be used when rendering the representation 500 to extend the context of the rendering of a model in cases where the rendering limitation imposed by the rendering device would not allow to render the whole 3D scene in full when the application had started. The placeholder geometry provides such context for existing geometry at different locations, and it is generated at a very low cost of representation so that high resolution can be mixed with medium/low resolution.

The utilization of a tile loading strategy and application of tile level of detail categories to determine what geometry to be downloaded can provide multiple technical advantages including:
in a real-time collaborative VR experience for multiple users that render geometry associated with a model for which a single tile loading strategy is applied and distributed to the rendering devices to categorize the level of detail for each tile and to prioritize rendering;
loading of models in an VR application can be done on a per tile basis rather than on a per object basis, which can support an efficient resource utilization for rendering groups of multiple objects.
does not require any data preparation or even downloading/loading of geometry at the computer to initiate rendering of placeholder geometry. The present techniques rely on the scene description data structure (e.g., as obtained at 210 of the process 200 of FIG. 2) defining location information for objects o and their bounding volumes.

The example representation 550 is of a view of the 3D model that corresponds to the view of the model at 500, however, the representation 550 includes rendered model geometry of the 3D model rather than placeholder geometry. For example, the helicopter 555 corresponds to the placeholder geometry box 505 from the representation 500, but the helicopter 555 is rendered with downloaded model geometry. For example, the example representation 550 of the 3D model on FIG. 5 is for rendering the view of the 3D model with a device that may not restrict the rendering so that when the tiles are categorized, all tiles can fall within the rendering limitations of the device and all the geometry can be rendered. As another example, the representation 550 of the 3D model show a rendering result that is subsequent to the rendering of the representation 500 of the 3D model. For example, after a period of time from rendering 500, the rendering device may re-evaluate all the tiles within the view frustrum and can manage to download and render all the geometry. The time between the rendering of the representation 500 to the representation 550 may depend on the rendering restrictions of the device, network connectivity with a remote storage for the geometry for the 3D model, and/or the specifics of the 3D model (e.g., size and density).

FIG. 4B shows an example of a process 460 for categorizing tiles defined for a 3D model based on computational rendering requirements of a display device used for rendering the 3D model during user interaction with the 3D model. The categorization of tiles to a level of detail category can be done as discussed in relation to FIGS. 2, 3, and 4A. The categorization of tiles can be triggered based on determining a position and an orientation of a user within a 3D scene, for which scene description is provided that includes location information comprising bounding volumes for the objects within the model.

At 465, information for a plurality of tiles defined for the 3D model is obtained. For example, the information is obtained based on the scene description data structure (such as the obtained scene description data structure at operation 210 of process 200 of FIG. 2). Objects of the 3D model can be grouped into a plurality of tiles by applying a tile loading strategy. For example, the objects can be grouped into tiles as shown on FIG. 4A. The scene description data structure can be generated based on such grouping of object into tiles according to the applied tile loading strategy.

At 470, each tile is categorized into a respective category of a set of categories, e.g., high, medium, or low. A category is indicative of a respective level of detail for rendering geometry associated with the respective tile. For example, for tiles with a high level of detail category, the rendered geometry is geometry of the objects of the 3D model as downloaded, while for tiles that are with low level of detail, the rendered geometry is placeholder geometry. It should be understood that object geometry for objects of a tile that is categorized as of a high level of detail tile is downloaded first when preparing to render the 3D model. If model geometry for some of those objects is not yet downloaded, placeholder geometry can be rendered for such objects to compliment the generation of a fuller picture and provide context for existing model geometry. The placeholder geometry can be generated to compensate for the delay in downloading of all the geometry for objects in high level of detail tiles.

Categorizing each tile into a respective level of detail from a set of levels of detail for a tile can include multiple operations. At 471, a maximum number of draw-call operations that are performable by the computer within a computation resource budget is determined. At 472, a number of draw-call operations associated with rendering each tile with each of the different level of details is determined. At 473, the tiles of the 3D model are ordered based on proximity to a position of the user within the 3D model. The position of the person can be obtained before the rendering is initiated to support processing of the tile loading strategy for the 3D model. At 474, the respective level of detail from the set of levels is assigned to each tile based on processing the tiles according to their order and evaluating the number of draw-call operations associated with rendering a respective tile and the maximum number of draw-call operations.

The tiles of the 3D model can be rendered with the respective level of detail as determined based on the above categorization operations. The definition of the category is based on the position of the user and the rendering limitations of the device. As such, the defined categories per tile can change in real-time while the user is navigating within the environment of the 3D model, e.g., performs a VR walkthrough the VR environment where the 3D model is rendered. For example, the tile categorization can be performed and level of detail categories can be assigned as shown and described in connection with FIG. 4A. At 475, in response to determining a change of the position and/or a viewpoint of the user, the categorization of each tile of the set of tiles to a respective category can be repeated. Based on such re-categorization, a new level of detail can be determined for the tiles of the 3D model.

FIG. 4C shows an example of a process 480 for dynamic rendering of portions of a 3D model including object geometries and placeholder geometries that are dynamically determined based on a rendering budget of a display device available for rendering the 3D model. The process 480 can be executed, for example, on a computer system, such as the computer 110 of FIG. 1, and through a client application, such as the client application 116. The process 480 can be executed to render a representation of a 3D model in a 3D space from a perspective of a user assigned with a position in the 3D space. Different portions of the 3D model can be rendered with different level of detail, for example, as described in relation to FIG. 4A.

At 481, a 3D scene description data structure encoding location information in the 3D model of the environment is obtained by a computer. The computer can process the 3D scene description data to prepare rendering of at least a portion of the 3D model in the environment. The computer includes a display device and local memory to load geometry of the 3D model when preparing to render a portion of the model with high level of detail, for example, as described in relation to FIGS. 2, 3, and 4A. The 3D model can be stored on a remote computer system, e.g., a cloud platform, and geometry for objects of the model can be downloaded based on categorizing tiles of the 3D model to a respective level of detail, e.g., as described in relation to FIG. 4B. The location information part of the scene description includes bounding volumes for objects in the 3D model that can support rendering geometry of objects of the model as well as placeholder geometry.

At 482, in response to obtaining information for a position of a user within the environment, a subset of the objects is downloaded at the computer (and from the remote computer system where the 3D model is stored). The downloaded subset of the objects is downloaded to the local memory of the computer. A tile loading strategy can be applied to the 3D model so that objects are divided into tiles. Information about the division of the objects into tiles is provided as part of the scene description. The 3D tiles are tiles that are located within a view frustrum of the user and within a focus radius defined for rendering object at the display device. For example, the 3D tiles can b such as the tiles with high level of detail as categorized on FIG. 4A. The subset of objects that are to be downloaded at 482, are objects that are within 3D tiles of a set of tiles defined for the objects in the 3D model. The 3D tiles can be tiles that are categorized to be rendered with the highest priority for rendering or with a lower priority for rendering in view of the rendering budget limitation of the computer. For example, tiles that are associated with a lower priority for rendering are tiles that are to be downloaded but that cannot be rendered due to rendering budget limitations of the computer.

At 483, a first portion of the subset of the objects is rendered by the computer. The first portion includes object geometries of respective objects in the first portion of the subset. The one or more tiles, which include objects to be rendered, can be associated with positions in the environment that are within a first threshold distance from the position associated with the user within the environment, as well as being within the view frustrum of the user. For example, the first portion of rendered objects are objects within tiles that are categorized as high level of detail tiles.

At 484, a set of placeholder objects corresponding to each object of a second portion of the subset of the objects is rendered by the computer. The objects in the second portion are located in one or more other tiles of the 3D tiles that are further away from the position of the user, for example, within a distance range between the threshold distance and a second threshold distance from the position of the user. For example, these objects can be objects in tiles that are with a middle level of detail category. Placeholder objects can be rendered as bounding geometry boxes irrespective of the shape of the object. The representation of the placeholder object as a box can facilitate case of manipulation of rotation of the object when rendering the placeholder from a different perspective associated with a modified position of the user within the environment. The box that is to be rendered can have a rectilinear shape, for example, a rectilinear prims or cube. In some instances, the boxes can be of rectilinear shaped box of 24 polygons. With such sized boxes, the vertex shader and the fragment shader of the GPU will handle these 24 polygons when rendering, which is in consideration with the limited rendering budget of the device. Defining the placeholder boxes to have a smaller number of polygons (e.g., 24 polygons) compared to the polygons associated with the model geometry supports processing efficiency and adjustment of the rendering to cover all tiles within the area of interest for the user, even if with a different level of detail. The processing load on the GPU increases with the increase of the polygons to be rendered. By having placeholder boxes with a low number of polygons, such as 24 polygons, more context about the 3D model can be provided to the user which is determined to support stable performance of the client application, e.g., without downtime for the rendering services provided, frame rendering delays, frozen screens, etc.

At 485, a second set of placeholder geometry boxes is rendered. An object of the second set of placeholder objects corresponds to a tile of the set of tiles that is categorized with low priority level for downloading and rendering. For example, the tiles corresponding to the tile of the set is not being downloaded by the computer, e.g., since it is categorized as a low level of detail tile.

In some instances, when a user modifies their position or their orientation within the 3D space, at least some of the downloaded objects can be removed based on a received indication for the change of the position and/or orientation. For example, objects that do not fall within the field of view of the user can be removed, and tiles of the 3D model can be reordered based on their proximity to the user's position and processed to recategorize the tiles to a respective level of detail category, e.g., as described in relation to FIG. 4B.

FIG. 6 shows an example of a visual representation 600 of a portion of a 3D model that is downloaded and rendered according to tile level of detail loading techniques in accordance with implementations of the present disclosure. The visual representation 600 is of a view of the 3D model from the inside, for example, in a 1:1 review mode, that is provided to a user associated with a particular location within the 3D model. The avatar 605 of the user is provided with a display of a view of the 3D model on their rendering device. In some instances, the avatar 605 can participate in a VR environment, where the 3D model is rendered in an immersive manner, and the user is provided with a view of the 3D model on a separate screen 640. The separate screen 640 can be considered as a virtual screen within the VR environment that can provide data associated with the 3D model in another format (e.g., 2D data, graphics, images, interactive content, etc.), or can include other data available to the user in the VR environment. For example, the separate screen 640 can simulate a virtual experience as if the user is inside a building and is interacting with his portable device while observing the geometry of the building in real time.

Different parts of the rendered visual representation 600 can be provided with a different color or other visual indication to indicate to the status of downloading and rendering. For example, tiles including objects that are rendered with their object geometry as downloaded from the 3D model corresponds to portions of the rendered scene that are closer to the user 605, for example, such as 620 and 625 of FIG. 6. Those parts of the 3D model (620 and 625) are rendered with a high level of detail as they correspond to tiles of the 3D model that are categorized as high level of detail tiles. A portion of the rendered geometry part of the representation 600 is placeholder geometry that is rendered for each object of a tile that is categorized as a middle level of detail tile. Such portion of the rendered geometry is part for example of area 610, that corresponds to tile(s) categorized as middle level of detail tile(s) according to the techniques of processing the tiles defined for the 3D model in the present implementation. The categorization of the tiles is determined with consideration of rendering limitations of the rendering device and can be different for another device different from the one associated with FIG. 6. Also, a portion of the rendered geometry is placeholder geometry that is generated for tile(s) that are categorized as low level of detail tiles, for example, in area 630.

FIG. 7 shows an example of a process 700 to render a portion of a 3D model that is downloaded along with visual indicators representing a portion of the 3D model that is still not downloaded. In some instances, when a view of a 3D model is rendered for a user, a portion of the model geometry may be still in progress of downloading, other geometry may be already downloaded, and some geometry may not be even triggered for downloading. Also, rendering status of different portions of the rendered view may be different and associated with rendering different geometry, e.g., downloaded geometry or placeholder geometry.

In some instances, the process 700 supports rendering a portion of a 3D model that provides visual feedback for the status of downloading and rendering of portions of the geometry that is already downloaded. Such feedback can improve the understanding and experience of the user so that there is no confusion that the downloading and/or rendering are in progress rather than an indication that the computer is experiencing downtime or other temporary unavailability, e.g., the computer is frozen to a particular rendered scene. Since dynamic feedback can be provided to the user, the computer can receive fewer requests for refreshing of the view, which may be triggered in case a misunderstanding of the status of downloading and rendering, or of the availability status of the device or the application. Further, the visual feedback indication can support improved user experience that is provided by efficiently utilizing the computing and rendering resources to manage the download and rendering of portions of a 3D model to fit into the resource limitations of the rendering device. Additionally, providing visual indicators when rendering geometry, such as placeholder geometry, can be performed without additional costs for the rendered. The visual indicators can be provided by the render without adding additional rendering load.

At 710, the 3D scene description encoding location information in the 3D model of the environment can be obtained, for example, as described in relation to FIGS. 2, 4A, and 4C. The scene description includes the definition of tiles for the 3D model, for example, generated based on applying a tile loading strategy that is defined based on the 3D model's density and the expected time to process the 3D model for rendering based on such distribution of objects into tiles. The 3D scene description includes location information for the bounding volumes of the objects in the 3D model, which provides information for rendering placeholder geometry for the objects or tiles to which they are allocated without downloading the real geometry from the 3D model.

At 720, a portion of the objects to the local memory is downloaded by the computer from a remote storage, e.g., cloud platform providing 3D model data. The portion of the data that is downloaded can be determined based on categorizing tiles of the 3D model according to an assignment of a level of detail per time from a set of level of detail, for example, in three categories as shown and described in connection with FIGS. 2, 3, 4A-C.

At 730, the portion of the objects along with one or more visual indicators representing a portion of the 3D model that is still to be downloaded is rendered. As such the portion of the objects that are downloaded and the portion of the object that are still to be downloaded is rendered in accordance with the scene description.

For example, the portion that is represented with one or more visual indicators can be the portion that is rendered with placeholder geometry as described for example in relation to operation 230 of the process 200 of FIG. 2, operations 483 or 484 of FIG. 4C. The one or more visual indicators can be positioned in the rendered 3D space in accordance with the bounding volumes in the scene description to provide feedback to a user regarding the status of object downloading. In some instances, the one or more visual indicators include respective visual representations for objects in the portion of the 3D model that are still to be downloaded or are about to be rendered when the rendering budget allows.

In some instances, the one or more visual indicators can provide the feedback to the user by rendering the portion of the 3D model with color or with a visual change, such as pulsation or modification of the used color, or combination thereof. In some instances, the color can be provided as pulsating feedback by making use of time and driving the color effect at the shader of the rendering device. The pulsating feedback can be configured to be visualized by applying a script that implements an algorithm to tell the processor how to render each pixel based on a particular material or texture. For example, a simple sine wave can be applied by a shader to provide the pulse effect of a given color used to render geometry bounding box representing placeholder geometry that is currently downloaded or about to be rendered.

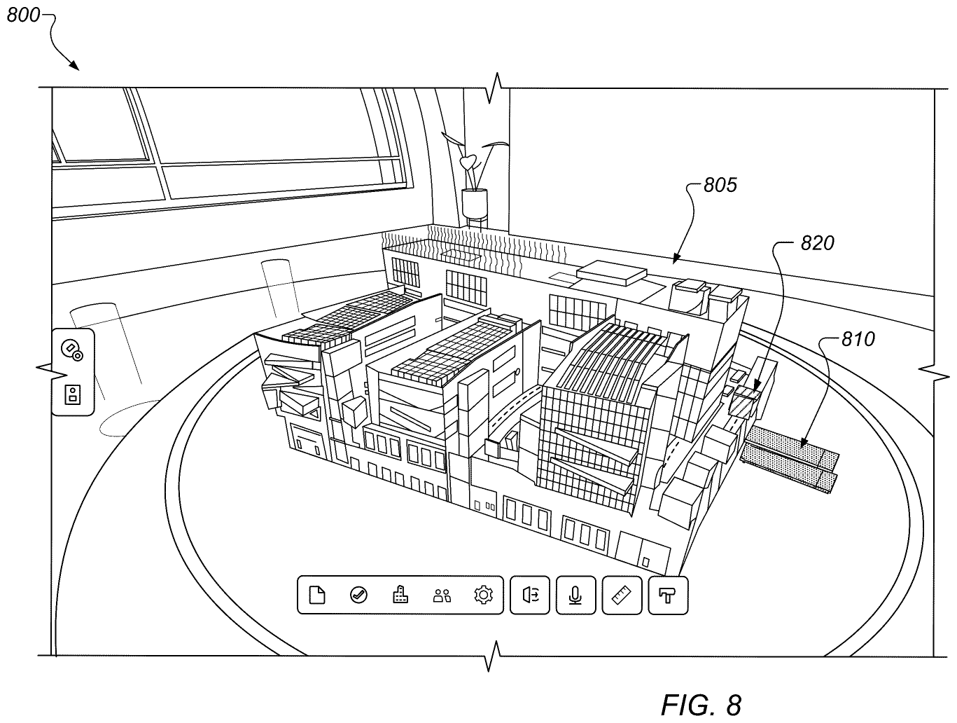

FIG. 8 shows an example of a virtual user interface 800 rendering a VR environment including a 3D model 805 that is rendered with visual indicators indicative of at least a first portion of the 3D model that is currently in download (810) and at least a second portion of the 3D model that is downloaded and not yet rendered (e.g., 820). In some instances, the visual indicators can be rendered as described in relation to FIG. 7. The example shows visual indicators that include color. Different color can be used to indicate the status of downloading of objects within the portion that is represented with the indicator. For example, portion of the model that is not yet downloaded can be indicated with a first color, while another portion of the model that is currently in downloading state can be indicated with a second color. In some instances, a portion of the model that is downloaded but not yet rendered can be indicated with a third color.

The 3D model rendered in the virtual user interface 800 can be processed and loaded into the cache of a rendering device as described in relation to FIGS. 2, 4A-4C, or another loading technique can be used, including the adaptive dynamic loading strategies for rendering 3D models, such as described in U.S. application Ser. No. 18/506,971, filed on Nov. 10, 2023, and titled, “ADAPTIVE DYNAMIC LOADING STRATEGY FOR RENDERING LARGE 3D MODELS”, which application is hereby incorporated by reference in its entirety.

In some instances, when tile loading strategy and geometry to be rendered is applied, object geometry of tiles of the model that are downloaded to the rendering device, are represented with high level of detail when they correspond to a tile that is assigned with a high level of detail category. Such geometry can be viewed by the user, however, other geometry of the model is not provided based on geometry downloaded from the model but rather as a placeholder geometry generated based on the scene description. For example, the visual indicators can be used to indicate that the placeholder geometry that is rendered is still to be downloaded, e.g., currently in the process of downloading or awaiting downloading to start, such as in the case when the tile is assigned with a middle level of detail as described in relation to FIG. 3. In the example of FIG. 8, the placeholder geometry that is rendered in the VR environment of can be rendered by using a first color (such as the color used to color a portion 810 of the representation that is with a dotted pattern) to shade the tiles that include objects that are still to be downloaded. Placeholder geometry that is rendered for geometry that is downloaded but not yet rendered can be provided with another shade, e.g., such as a second different color to color portion 820 of the representation that is with a strike through line pattern). Other portions of the scene can be rendered with placeholder geometry along with visual indicators that is not shown on FIG. 8. The placeholder visual indications for the portions 810 and 820 is an example, and other geometry is also rendered with relevant visual indications according to the level of detail even if not shown on representation 800 of FIG. 8.

In some instances, the representation of visual indicators for portions of the geometry, that is not yet downloaded or rendered, can be provided by the client application when rendering a portion of the 3D model in real time as well as dynamically after the client application has started and an initial load of the application has been performed. Sometimes, when a real-time real experience is provided (e.g., in a collaborative setup), the user can reposition themselves within the environment and depending on their position and available rendering budget (performance/FPS) of the rendering device that the user is using, different portions of the geometry are to be downloaded and rendered. If the user moves close to a tile of a group of tiles, it may be possible that the rendering device cannot recategorize the tiles based on the position change because there were other downloading operations for other object geometry that had been started but had not yet finished. Thus, there can be a time delay to be able to render more geometry of the model for the user at the new position.

If there is no progress indication or feedback to provide a notification to the user of the status of the performed downloading and/or rendering, the user may experience misunderstanding whether the device is experiencing downtime or temporary unavailability, whether the connection to a remote storage where the 3D model is stored had dropped, or there is other technical issue with the execution of the application that is used. Instead of providing a progress bar, a progress indication for the status of downloading of specific portions of object geometry from the 3D model can be provided through visual indications for those specific portions, as shown on FIG. 8.

For example, without a visual indication when rendering large 3D models, users doing a model walkthrough in a VR application can presume that the model loading is stuck or frozen because the tiles are taking too much time to provide different level of detail (e.g., switch from mid to high level of detail), when the user had moved towards them. Users may also not be able to tell if the model loading is progressing or not because there was no visual indication to differentiate between the loaded tiles and the tiles which are still loading geometry. Without visual indication, users are not able to conduct an efficient review session for a model because of all interruptions in the user experience that can lead to multiple device reboots.

In other solutions, no geometry is shown until the geometry has loaded. Usually, this is indicated by a loading bar shown before any geometry or model is presented to the user. Once the geometry is loaded, the geometry is shown in white until textures/materials are loaded in the virtual user interface where the 3D model is shown. When the textures and materials are loaded, the rendering can be performed by swamping the white representation with a correct representation of the geometry as per the model object.

In contrast, the combined use of placeholder geometry (e.g., bounding box representation) of the geometry (according to a determined level of detail category) in a tile and visual feedback (such as color or pulse loading feedback as visual indicators for the status of downloading for the object geometry) in real time when the model is to be represented allows to represent the general form of the model before any geometry has started being downloaded. The dynamic pulsing represents loading in a third dimension instead of relying on a simple two-dimensional progress bar that can be rendered as a separate user interface element in the user interface 800.

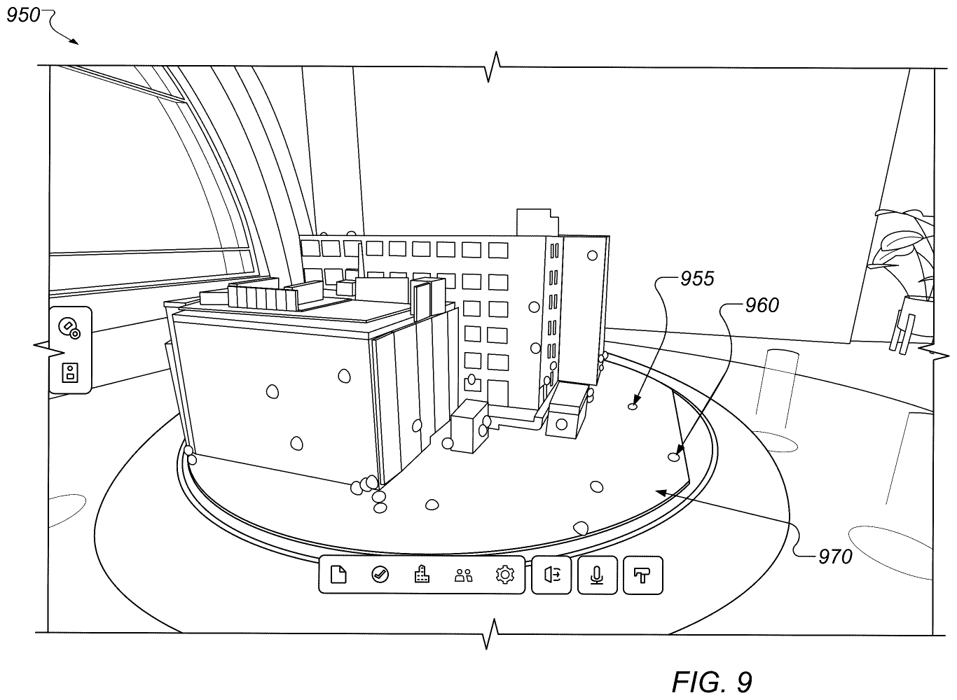

In some instances, other form of visual indication can be provided, for example, with pulsating feedback as shown on FIG. 9. FIG. 9 shows an example of a second view 950 of the 3D model of FIG. 8 that includes pulsating indicators such as 955 and 960 for the first portion 970 representing a round area around the building at a ground level) of the 3D model that is currently downloaded. The pulsating indicators immediately show which parts of the model are being downloaded, for example, the first portion 970 that includes pulsating indicators. In some instances, the rendering of visual indicators can include displaying a pulsating (e.g., color) overlay on the tiles of the model, which are still downloading geometry that is to be rendered inside the experience. By using bounding box representation as placeholder geometry for all geometry in a tile, a semi-realistic representation of the geometry can be provided. The representation of the placeholder geometry as a bounding box facilitates prompt rendering of a new view of the model based on a repositioning of the user, since the boxes has a shape that is easy to be rendered from various locations according to the changed location of the user without adding extra computational time or resource requirements.

In some instances, combining the representation of the 3D model based on loading strategies (e.g., tile loading strategy and level of detail categorization as described in relation to FIGS. 2, 3, 4A-4B, or through) and pulsing overlay feedback, the application that provides the VR experience to the user can notify the user that the tile loading is in progress. This use of bounding boxes as placeholders that can be rendered from another perspective to a user while that user is walking through the VR environment can vastly speed up the time it takes to represent the geometry and can improve the loading experience for the user. Such feedback helps the user to understand that the application and/or the user session is not frozen or stuck, or for example as a result of network connectivity issues. The pulsating feedback ends when the tile finishes loading/downloading all the model geometry grouped within that tile. As such, during a user experience in the user interface where a portion of the 3D model is provided with visual indicators, the rendering of the visual indicators can change not only based on repositioning of the user in the space so that another classification of the level of detail for the tiles can be performed but also with regard to the execution of the downloading. When downloading object geometry is completed, the visual indicator for that object geometry can change, while other object geometry for another object that has started to be downloaded can be rendered together with a visual indicator to show the status of downloading.

In some instances, the pulse feedback can make use of time and a simple sine wave to be applied to the shader when rendering to drive the pulsating effect. Including such pulsating feedback can be performed without inclusion of any additional overhead to the rendering representation during loading.

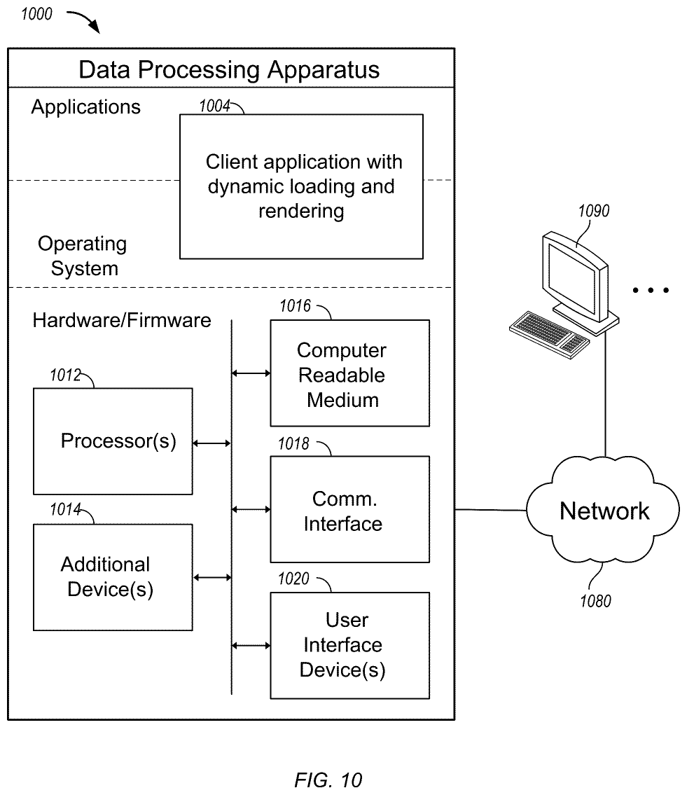

FIG. 10 is a schematic diagram of a data processing system including a data processing apparatus, which can be programmed as a client or as a server. The data processing apparatus 1000 is connected with one or more computers 1090 through a network 1080. While only one computer is shown in FIG. 10 as the data processing apparatus 1000, multiple computers can be used. The data processing apparatus 1000 includes various software modules, which can be distributed between an applications layer and an operating system. These can include executable and/or interpretable software programs or libraries, including tools and services of a client application 1004 that includes a user interface that allows displaying of a 3D model of environments to a user of the client application 1004 in one or more review modes. Further, the client application 1004 can implement a tile loading strategy to determine to download and render a portion of the objects of a 3D model along with placeholder geometry for tiles that are not yet downloaded and/or not to be rendered. Such loading and rendering can support stable performance of the client device without causing downtime due to loading or rendering overload.

The number of software modules used can vary from one implementation to another. Moreover, the software modules can be distributed on one or more data processing apparatus connected by one or more computer networks or other suitable communication networks.

The data processing apparatus 1000 also includes hardware or firmware devices including one or more processors 1012, one or more additional devices 1014, a computer readable medium 1016, a communication interface 1018, and one or more user interface devices 1020. Each processor 1012 is capable of processing instructions for execution within the data processing apparatus 1000. In some implementations, the processor 1012 is a single or multi-threaded processor. Each processor 1012 is capable of processing instructions stored on the computer readable medium 1016 or on a storage device such as one of the additional devices 1014. The data processing apparatus 1000 uses the communication interface 1018 to communicate with one or more computers 1090, for example, over the network 1080. Examples of user interface devices 1020 include a display, a camera, a speaker, a microphone, a tactile feedback device, a keyboard, a mouse, and VR and/or AR equipment. The data processing apparatus 1000 can store instructions that implement operations associated with the program(s) described above, for example, on the computer readable medium 1016 or one or more additional devices 1014, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that produces an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing, and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other units suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors, executing one or more computer programs to perform functions by operating on input data and generating output. The processes and logic flows can also be performed by, and apparatus can also be implemented as, special purpose logic circuitry, e.g., a field programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read-only memory or a random access memory, or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a liquid crystal display (LCD) device, an organic light emitting diode (OLED) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other, and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface, through which a user can interact with an implementation of the subject matter described in this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

### Embodiments

### Tile Loading Strategy for Rendering 3D Models

Embodiment 1. A computer-implemented method comprising:
obtaining, by a computer having a display device and local memory, a 3D scene description data structure encoding location information in a 3D model of an environment, wherein the 3D model is stored on a remote computer system, and the location information comprises bounding volumes for objects in the 3D model;
downloading, by the computer and from the remote computer system, a portion of the objects to the local memory; and
rendering, by the computer, the portion of the objects along with one or more 3D tiles representing a portion of the 3D model in which at least one of the objects that has not been downloaded is located, in accordance with the scene description data structure.

Embodiment 2. A computer-implemented method comprising:
obtaining, by a computer having a display device and local memory, a 3D scene description data structure encoding location information in a 3D model of an environment, wherein the 3D model is stored on a remote computer system, and the location information comprises bounding volumes for objects in the 3D model;
in response to obtaining information for a position of a user within the environment, downloading, by the computer and from the remote computer system, a subset of the objects from the 3D model to the local memory, wherein the subset of objects is within 3D tiles of a set of tiles defined for the objects in the 3D model, the 3D tiles being located within a view frustrum of the user and within a focus radius defined for rendering object at the display device; and
rendering, by the computer, a first portion of the subset of the objects, the first portion being rendered to include object geometries of respective objects in the first portion of the subset, wherein the respective objects are located within one or more tiles of the 3D tiles, the one or more tiles being located within a threshold distance from the position of the user within the environment and within the view frustrum of the user.

Embodiment 3. The method of Embodiment 2, wherein the threshold distance is a first threshold distance, and the method comprises:
rendering, by the computer, a set of placeholder objects corresponding to each object of a second portion of the subset of the objects, wherein the objects in the second portion are located in one or more other tiles of the 3D tiles that are further away from the position of the user beyond the threshold distance and within a second threshold distance from the position of the user.

Embodiment 4. The method of Embodiment 2, wherein downloading the subset of the objects comprises:
grouping the objects into the 3D model into the set of tiles by applying a tile loading strategy; and
categorizing each tile into a respective category of a set of categories, a category being indicative of a priority level for downloading and rendering the respective tile at the display device.

Embodiment 5. The method of Embodiment 4, wherein the 3D tiles associated with the subset of the objects that are downloaded are categorized with respective categories matching a rendering criteria indicative of performance bandwidth of the display device.

Embodiment 6. The method of Embodiment 4, wherein the threshold distance is a first threshold distance, and wherein categorizing each tile comprises:
associating a tile of the set of tiles with a first category associated with a highest priority level for rendering based on determining that the tile is within a user's view frustrum and is within the first threshold distance from the position of the user.

Embodiment 7. The method of Embodiment 4, the method comprising:
rendering, by the computer, a second set of placeholder objects, wherein an object of the second set corresponds to a tile of the set of tiles that is categorized with low priority level for downloading and rendering, the tile of the set not being downloaded by the computer.

Embodiment 8. The method of Embodiment 2, comprising:
removing, by the computer, downloaded objects based receiving indications for changes in at least one of a user's viewpoint or the position of the user within the environment.

Embodiment 9. The method of Embodiment 8, comprising:
in response to determining a change of the position and/or a viewpoint of the user, repeating the categorization of each tile of the set of tiles based on re-applying the tile loading strategy.

Embodiment 10 A system comprising:
a non-transitory storage medium having instructions of a 3D modeling program stored thereon; and
one or more data processing apparatus configured to run the instructions of the 3D modeling program to perform operations according to any of method Embodiments 1-9.

Embodiment 11. A non-transitory computer-readable medium encoding instructions operable to cause data processing apparatus to perform operations according to any of method Embodiment 1-9.

Level of Detail Loading Strategy with Feedback for Downloading and Rendering Status

Embodiment 1. A computer-implemented method comprising:
obtaining, by a computer having a display device and local memory, a 3D scene description data structure encoding location information in a 3D model of an environment, wherein the 3D model is stored on a remote computer system, and the location information comprises bounding volumes for objects in the 3D model;
downloading, by the computer and from the remote computer system, a portion of the objects to the local memory; and
rendering, by the computer, the portion of the objects along with one or more visual indicators representing a portion of the 3D model that is still to be downloaded, wherein the one or more visual indicators are placed in 3D space in accordance with the bounding volumes in the scene description data structure to provide feedback to a user regarding the status of object downloading.

Embodiment 2. The method of Embodiment 1, wherein the one or more visual indicators comprise respective visual representations for objects in the portion of the 3D model that are still to be downloaded.

Embodiment 3. The method of any one of Embodiments 1-2, wherein the one or more visual indicators comprise a color that provides the feedback to the user regarding the status of object downloading.

Embodiment 4. The method of any one of Embodiments 1-3, wherein the one or more visual indicators comprise a visual change that provides the feedback to the user regarding the status of object downloading.

Embodiment 5. The method of any one of Embodiments 1-4, wherein the visual change comprises pulsation.

Embodiment 6. The method of any one of Embodiments 1-5, wherein the rendering comprises rendering, by the computer, the portion of the objects along with one or more 3D tiles representing the portion of the 3D model in which at least one of the objects that has not been downloaded is located, in accordance with the scene description data structure.

Embodiment 7. The method of any one of Embodiments 1-5, comprising:
in response to obtaining information for a position of a user within the environment, downloading, by the computer and from the remote computer system, a subset of the objects from the 3D model to the local memory, wherein the subset of objects is within 3D tiles of a set of tiles defined for the objects in the 3D model, the 3D tiles being located within a view frustrum of the user and within a focus radius defined for rendering object at the display device; and
rendering, by the computer, a first portion of the subset of the objects, the first portion being rendered to include object geometries of respective objects in the first portion of the subset, wherein the respective objects are located within one or more tiles of the 3D tiles, the one or more tiles being located within a threshold distance from the position of the user within the environment and within the view frustrum of the user.

Embodiment 8. The method of Embodiment 7, wherein the threshold distance is a first threshold distance, and the method comprises:
rendering, by the computer, a set of placeholder objects corresponding to each object of a second portion of the subset of the objects, wherein the objects in the second portion are located in one or more other tiles of the 3D tiles that are further away from the position of the user beyond the threshold distance and within a second threshold distance from the position of the user.

Embodiment 9. The method of Embodiment 7, wherein downloading the subset of the objects comprises:
grouping the objects into the 3D model into the set of tiles by applying a tile loading strategy; and
categorizing each tile into a respective category of a set of categories, a category being indicative of a priority level for downloading and rendering the respective tile at the display device.

Embodiment 10. The method of Embodiment 9, wherein the 3D tiles associated with the subset of the objects that are downloaded are categorized with respective categories matching a rendering criteria indicative of performance bandwidth of the display device.

Embodiment 11. The method of Embodiment 9, wherein the threshold distance is a first threshold distance, and wherein categorizing each tile comprises:
associating a tile of the set of tiles with a first category associated with a highest priority level for rendering based on determining that the tile is within a user's view frustrum and is within the first threshold distance from the position of the user.

Embodiment 12. The method of Embodiment 9, comprising:
rendering, by the computer, a second set of placeholder objects, wherein an object of the second set corresponds to a tile of the set of tiles that is categorized with low priority level for downloading and rendering, the tile of the set not being downloaded by the computer.

Embodiment 13. The method of Embodiment 7, comprising:
removing, by the computer, downloaded objects based receiving indications for changes in at least one of a user's viewpoint or the position of the user within the environment.

Embodiment 14. The method of Embodiment 13, comprising:
in response to determining a change of the position and/or a viewpoint of the user, repeating the categorization of each tile of the set of tiles based on re-applying the tile loading strategy.

Embodiment 15. A system comprising:
a non-transitory storage medium having instructions of a 3D modeling program stored thereon; and
one or more data processing apparatus configured to run the instructions of the 3D modeling program to perform operations according to any of method Embodiments 1-14.

Embodiment 16. A non-transitory computer-readable medium encoding instructions operable to cause data processing apparatus to perform operations according to any of method Embodiment 1-14.

### Examples

Although the present application is defined in the attached claims, it should be understood that the present invention can also (additionally or alternatively) be defined in accordance with the following examples:

Example 1. A computer-implemented method comprising:
obtaining, by a computer having a display device and local memory, a three-dimensional scene description data structure encoding location information in a three-dimensional model of an environment, wherein the three-dimensional model is stored on a remote computer system, and the location information comprises bounding volumes for objects in the three-dimensional model;
downloading, by the computer and from the remote computer system, a portion of the objects to the local memory; and
rendering, by the computer, the portion of the objects along with one or more three-dimensional tiles representing a portion of the three-dimensional model in which at least one of the objects of the three-dimensional model that has not been downloaded is located, in accordance with the three-dimensional scene description data structure.

Example 2. The method of Example 1, wherein the portion of the objects that is downloaded is determined according to i) a position of a user within the environment and ii) rendering costs associated with rendering geometry of different level of detail for objects associated with a set of tiles defined for the three-dimensional model, the set of tiles being within a view frustrum of the user.

Example 3. The method of Example 1 or Example 2, wherein the downloading and the rendering are performed based on an interaction of a user of the computer with the three-dimensional model of the environment, wherein the user is associated with a location within the three-dimensional model, and wherein the downloaded portion of the objects is rendered with object geometries as downloaded from the three-dimensional model, the respective objects being located within one or more tiles of a plurality of three-dimensional tiles defined for the three-dimensional model.

Example 4. The method of any one of the preceding Examples, wherein the one or more tiles are located within a threshold distance from the location of a user within the three-dimensional model and within a view frustrum of the user, wherein the threshold distance is determined based on available computational resources of the computer to render geometry representations and a density of the three-dimensional model.

Example 5. The method of Example 4, wherein the threshold distance is determined according to i) a rendering budget of the computer for rendering the portion of the objects along with the one or more three-dimensional tiles and ii) a density of the three-dimensional model.

Example 6. The method of any one of the preceding Examples, wherein the three-dimensional scene description data structure comprises a definition of a plurality of three-dimensional tiles for the three-dimensional model, the plurality of three-dimensional tiles being defined based on i) a density of the three-dimensional model and ii) expected time needed to process the plurality of three-dimensional tiles to determine objects of the three-dimensional model to be downloaded and to render downloaded objects with regard to requests from multiple users collaboratively reviewing the three-dimensional model from respective computers based on the three-dimensional scene description data structure.

Example 7. The method of any one of the preceding Examples, wherein each of the one or more three-dimensional tiles is rendered as one or more respective geometry box representations, wherein a geometry box representation represents one or more objects of the three-dimensional model for which no model geometry of the portion of the three-dimensional model is downloaded and rendered.

Example 8. The method of any one of the preceding Examples, wherein the one or more three-dimensional tiles, representing the portion of the three-dimensional model in which at least one of the objects that has not been downloaded, comprises a three-dimensional tile that is assigned with a rendering priority that defines that model geometry of objects within the three-dimensional tile is not to be rendered, wherein the rendering priority is determined based on assessing rendering costs for the three-dimensional tile including costs for rendering i) the three-dimensional tile as geometry for each object in the three-dimensional tile from the three-dimensional model, ii) the three-dimensional tile as a geometry placeholder for each object in the three-dimensional tile from the three-dimensional model, and iii) the three-dimensional tile as a single geometry placeholder box for the three-dimensional tile.

Example 9. The method of any one of the preceding Examples, wherein downloading the portion of the objects comprises:
obtaining information for a plurality of tiles defined for the three-dimensional model, wherein objects of the three-dimensional model are grouped into the plurality of tiles by applying a tile loading strategy; and
categorizing each tile into a respective category of a set of categories, a category being indicative of a respective level of detail for rendering geometry associated with the respective tile, wherein categorizing each tile into a respective level of detail from a set of levels of detail for a tile comprises:
   determining a maximum number of draw-call operations that are performable by the computer within a computation resource budget of the computer;
   determining a number of draw-call operations associated with rendering each tile with respective different categories for the level of details;
   ordering the tiles based on proximity to a position of a user within the three-dimensional model, wherein the user is associated with the downloading and rendering; and
   assigning the respective level of detail from the set of levels to each tile based on processing the tiles according to their order and evaluating the number of draw-call operations associated with rendering a respective tile and the maximum number of draw-call operations.

Example 10. The method of Example 9, comprising:
in response to determining a change of the position and/or a viewpoint of the user, repeating categorizing each tile of the set of tiles to a respective category.

Example 11. The method of any one of the preceding Examples, wherein the one or more three-dimensional tiles representing the portion of the three-dimensional model are rendered as one or more visual indicators indicative of a status of downloading and rendering the portion of the three-dimensional model.

Example 12. The method of Example 11, wherein the status for each visual indicator is one of i) currently downloading of corresponding geometry of objects of the three-dimensional model, ii) downloaded but not to be rendered, or iii) currently processing to render.

Example 13. The method of Example 11 or Example 12, wherein the one or more visual indicators comprise respective visual representations for objects that are in the portion of the three-dimensional model and are still to be downloaded.

Example 14. The method of Examples 11 to 13, wherein the one or more visual indicators comprise a color that provides feedback regarding the status of downloading and rendering.

Example 15. The method of any one of Examples 11 to 14, wherein the one or more visual indicators comprise a visual change that provides feedback regarding a status of downloading and rendering.

Example 16. A computer-implemented method comprising:
obtaining, by a computer having a display device and local memory, a three-dimensional scene description data structure encoding location information in a three-dimensional model of an environment, wherein the three-dimensional scene description data structure defines a set of tiles for objects of the three-dimensional model, wherein the three-dimensional model is stored on a remote computer system, and wherein the location information comprises bounding volumes for the tiles and for the objects of the three-dimensional model;
in response to obtaining information for a position of a user within the environment, downloading, by the computer and from the remote computer system, a subset of the objects from the three-dimensional model to the local memory, wherein the subset of objects is within three-dimensional tiles of the set of tiles defined for the objects in the three-dimensional model, the three-dimensional tiles being located within a view frustrum of the user and within a focus radius defined for rendering object at the display device; and
rendering, by the computer, a first portion of the subset of the objects, the first portion being rendered to include object geometries of respective objects in the first portion of the subset, wherein the respective objects are located within one or more tiles of the three-dimensional tiles, the one or more tiles being located within a threshold distance from the position of the user within the environment and within the view frustrum of the user.

Example 17. The method of Example 16, wherein the threshold distance is a first threshold distance, and the method comprises:
rendering, by the computer, a set of placeholder objects corresponding to each object of a second portion of the subset of the objects, wherein the objects in the second portion are located in one or more other tiles of the three-dimensional tiles that are further away from the position of the user beyond the threshold distance and within a second threshold distance from the position of the user.

Example 18. The method of Examples 16 or 17, wherein downloading the subset of the objects comprises:
grouping the objects into the three-dimensional model into the set of tiles by applying a tile loading strategy; and
categorizing each tile into a respective category of a set of categories, a category being indicative of a priority level for downloading and rendering of geometry associated with the respective tile at the display device.

Example 19. The method of Example 18, comprising:
in response to determining a change of the position and/or a viewpoint of the user, repeating the categorization of each tile of the set of tiles based on re-applying the tile loading strategy.

Example 20. The method of Example 18 or Example 19, the method comprising:
rendering, by the computer, a second set of placeholder objects, wherein an object of the second set corresponds to a tile of the set of tiles that is categorized with low priority level for downloading and rendering, the tile of the set not being downloaded by the computer.

Example 21. The method of any one of Examples 18 to 20, wherein the three-dimensional tiles associated with the subset of the objects that are downloaded are categorized with respective categories matching a rendering criteria indicative of performance bandwidth of the display device.

Example 22. The method of any one of Examples 18 to 21, wherein the threshold distance is a first threshold distance, and wherein categorizing each tile comprises:
associating a tile of the set of tiles with a first category associated with a highest priority level for rendering based on determining that the tile is within a user's view frustrum and is within the first threshold distance from the position of the user.

Example 23. The method of any one of Examples 16 to 22, comprising: removing, by the computer, downloaded objects based receiving indications for changes in at least one of a user's viewpoint or the position of the user within the environment.

Example 24. A computer-implemented method comprising:
obtaining, by a computer having a display device and local memory, three-dimensional scene description data structure encoding location information in a three-dimensional model of an environment, wherein the three-dimensional model is stored on a remote computer system, and the location information comprises bounding volumes for objects in the three-dimensional model;
downloading, by the computer and from the remote computer system, a portion of the objects to the local memory; and
rendering, by the computer, the portion of the objects along with one or more visual indicators representing a portion of the three-dimensional model that is still to be downloaded, wherein the one or more visual indicators are placed in three-dimensional space in accordance with the bounding volumes in the three-dimensional scene description data structure to provide feedback to a user regarding a status of object downloading.

Example 25. The method of Example 24, wherein the one or more visual indicators comprise respective visual representations for objects in the portion of the three-dimensional model that are still to be downloaded.

Example 26. The method of Example 24 or Example 25, wherein the one or more visual indicators are rendered as part of rendering one or more placeholder bounding boxes for objects that are part of the portion of the three-dimensional model that is still to be downloaded.

Example 27. The method of any one of Examples 24 to 26, wherein the rendering comprises rendering, by the computer, the portion of the objects along with the one or more placeholder bounding boxes corresponding to one or more three-dimensional tiles representing the portion of the three-dimensional model, wherein the rendering is performed in accordance with the three-dimensional scene description data structure.

Example 28. The method of any one of Examples 24 to 27, wherein the one or more visual indicators comprise a color that provides the feedback to the user regarding the status of object downloading.

Example 29. The method of any one of Examples 24 to 28, wherein the one or more visual indicators comprise a visual change that provides the feedback to the user regarding the status of object downloading.

Example 30. The method of Example 29, wherein the visual change comprises pulsation.

Example 31. The method of any one of Examples 24 to 30, comprising:
in response to obtaining information for a position of a user within the environment, determining, by the computer and from the remote computer system, a set of tiles from a plurality of tiles defined for the three-dimensional model for rendering, where the set of tiles comprise a subset of the objects from the three-dimensional model, the set of tiles being located within a view frustrum of the user and within a focus radius defined for rendering object at the display device,
wherein the portion of the objects that is rendered includes a first portion of the subset of the objects, wherein the first portion of the subset of the objects are located within one or more tiles of the set of tiles that are located within a first threshold distance from the position of the user within the environment and within the view frustrum of the user.

Example 32. The method of Example 31, comprising:
rendering, by the computer, a set of placeholder objects corresponding to each object of a second portion of the subset of the objects, wherein the objects in the second portion are located in one or more other tiles of the set of three-dimensional tiles that are further away from the position of the user beyond the first threshold distance and within a second threshold distance from the position of the user, wherein the objects of the second portion of the subset of objects are still not downloaded, and wherein the set of placeholder objects are rendered with a respective visual indicator, the visual indicator being rendered as part of rendering the set of placeholder objects.

Example 33. The method of Example 32, wherein the set of placeholder objects comprise bounding boxes rendered for objects that are part of the portion of the three-dimensional model that is still to be downloaded, wherein the bounding boxes are determined based on the location information including the bounding volumes for the objects in the three-dimensional model.

Example 34. A system comprising:
a non-transitory storage medium having instructions of a three-dimensional modeling program stored thereon; and
one or more data processing apparatus configured to run the instructions of the three-dimensional modeling program to perform operations of any one of the methods of Examples 1 to 33.

Example 35. A non-transitory computer-readable medium encoding instructions operable to cause data processing apparatus to perform operations of any one of the methods of Examples 1 to 33.

What is claimed is:

1. A computer-implemented method comprising:
obtaining, by a computer having a display device and local memory, three-dimensional scene description data structure encoding location information in a three-dimensional model of an environment, wherein the three-dimensional model is stored on a remote computer system, and the location information comprises bounding volumes for objects in the three-dimensional model;
downloading, by the computer and from the remote computer system, a portion of the objects to the local memory; and
rendering, by the computer, the portion of the objects along with one or more visual indicators representing a portion of the three-dimensional model that is still to be downloaded, wherein the one or more visual indicators are placed in three-dimensional space in accordance with the bounding volumes in the three-dimensional scene description data structure to provide feedback to a user regarding a status of object downloading.

2. The method of claim 1, wherein the one or more visual indicators comprise respective visual representations for objects in the portion of the three-dimensional model that are still to be downloaded.

3. The method of claim 1, wherein the one or more visual indicators are rendered as part of rendering one or more placeholder bounding boxes for objects that are part of the portion of the three-dimensional model that is still to be downloaded.

4. The method of claim 3, wherein the rendering comprises rendering, by the computer, the portion of the objects along with the one or more placeholder bounding boxes corresponding to one or more three-dimensional tiles representing the portion of the three-dimensional model, wherein the rendering is performed in accordance with the three-dimensional scene description data structure.

5. The method of claim 1, wherein the one or more visual indicators comprise a color that provides the feedback to the user regarding the status of object downloading.

6. The method of claim 1, wherein the one or more visual indicators comprise a visual change that provides the feedback to the user regarding the status of object downloading.

7. The method of claim 6, wherein the visual change comprises pulsation.

8. The method of claim 1, comprising:
in response to obtaining information for a position of a user within the environment, determining, by the computer and from the remote computer system, a set of tiles from a plurality of tiles defined for the three-dimensional model for rendering, where the set of tiles comprise a subset of the objects from the three-dimensional model, the set of tiles being located within a view frustrum of the user and within a focus radius defined for rendering object at the display device,
wherein the portion of the objects that is rendered includes a first portion of the subset of the objects, wherein the first portion of the subset of the objects are located within one or more tiles of the set of tiles that are located within a first threshold distance from the position of the user within the environment and within the view frustrum of the user.

9. The method of claim 8, comprising:
rendering, by the computer, a set of placeholder objects corresponding to each object of a second portion of the subset of the objects, wherein the objects in the second portion are located in one or more other tiles of the set of three-dimensional tiles that are further away from the position of the user beyond the first threshold distance and within a second threshold distance from the position of the user, wherein the objects of the second portion of the subset of objects are still not downloaded, and wherein the set of placeholder objects are rendered with a respective visual indicator, the visual indicator being rendered as part of rendering the set of placeholder objects.

10. The method of claim 9, wherein the set of placeholder objects comprise bounding boxes rendered for objects that are part of the portion of the three-dimensional model that is still to be downloaded, wherein the bounding boxes are determined based on the location information including the bounding volumes for the objects in the three-dimensional model.

11. A system comprising:
a non-transitory storage medium having instructions of a three-dimensional modeling program stored thereon; and
one or more data processing apparatus configured to run the instructions of the three-dimensional modeling program to perform operations comprising:
obtaining, by a computer having a display device and local memory, three-dimensional scene description data structure encoding location information in a three-dimensional model of an environment, wherein the three-dimensional model is stored on a remote computer system, and the location information comprises bounding volumes for objects in the three-dimensional model;
downloading, by the computer and from the remote computer system, a portion of the objects to the local memory; and
rendering, by the computer, the portion of the objects along with one or more visual indicators representing a portion of the three-dimensional model that is still to be downloaded, wherein the one or more visual indicators are placed in three-dimensional space in accordance with the bounding volumes in the three-dimensional scene description data structure to provide feedback to a user regarding a status of object downloading.

12. The system of claim 11, wherein the one or more visual indicators comprise respective visual representations for objects in the portion of the three-dimensional model that are still to be downloaded.

13. The system of claim 11, wherein the one or more visual indicators are rendered as part of rendering one or more placeholder bounding boxes for objects that are part of the portion of the three-dimensional model that is still to be downloaded.

14. The system of claim 13, wherein the rendering comprises rendering, by the computer, the portion of the objects along with the one or more placeholder bounding boxes corresponding to one or more three-dimensional tiles representing the portion of the three-dimensional model, wherein the rendering is performed in accordance with the three-dimensional scene description data structure.

15. The system of claim 11, wherein the one or more visual indicators comprise a color that provides the feedback to the user regarding the status of object downloading.

16. The system of claim 11, wherein the one or more visual indicators comprise a visual change that provides the feedback to the user regarding the status of object downloading.

17. The system of claim 11, wherein the one or more data processing apparatus is configured to perform instructions comprising:
in response to obtaining information for a position of a user within the environment, determining, by the computer and from the remote computer system, a set of tiles from a plurality of tiles defined for the three-dimensional model for rendering, where the set of tiles comprise a subset of the objects from the three-dimensional model, the set of tiles being located within a view frustrum of the user and within a focus radius defined for rendering object at the display device,
wherein the portion of the objects that is rendered includes a first portion of the subset of the objects, wherein the first portion of the subset of the objects are located within one or more tiles of the set of tiles that are located within a first threshold distance from the position of the user within the environment and within the view frustrum of the user.

18. A non-transitory computer-readable medium encoding instructions operable to cause data processing apparatus to perform operations comprising:
obtaining, by a computer having a display device and local memory, three-dimensional scene description data structure encoding location information in a three-dimensional model of an environment, wherein the three-dimensional model is stored on a remote computer system, and the location information comprises bounding volumes for objects in the three-dimensional model;
downloading, by the computer and from the remote computer system, a portion of the objects to the local memory; and
rendering, by the computer, the portion of the objects along with one or more visual indicators representing a portion of the three-dimensional model that is still to be downloaded, wherein the one or more visual indicators are placed in three-dimensional space in accordance with the bounding volumes in the three-dimensional scene description data structure to provide feedback to a user regarding a status of object downloading.

19. The non-transitory computer-readable medium of claim 18, wherein the one or more visual indicators are rendered as part of rendering one or more placeholder bounding boxes for objects that are part of the portion of the three-dimensional model that is still to be downloaded.

20. The non-transitory computer-readable medium of claim 19, wherein the rendering comprises rendering, by the computer, the portion of the objects along with the one or more placeholder bounding boxes corresponding to one or more three-dimensional tiles representing the portion of the three-dimensional model, wherein the rendering is performed in accordance with the three-dimensional scene description data structure.
